(19) United States
(12) Patent Application Publication
(10) Pub. No.: US 2011/0112892 A1
(43) Pub. Date: May 12, 2011

(54) Multi-location based promotion method and apparatus

(76) Inventor: Elia Rocco Tarantino, Las Vegas, NV (US)

(21) Appl. No.: 12/657,534

(22) Filed: Jan. 22, 2010

Related U.S. Application Data
(60) Provisional application No. 61/280,679, filed on Nov. 6, 2009.

(51) Int. Cl. G06Q 30/00; H04W 4/02

(52) U.S. Cl. 705/14.1; 705/14.58; 455/456.3

(57) ABSTRACT

A promotion system provides multi-location promotions for a variety of establishments. Establishments may define one or more zones and associate unique promotions to the zones. The promotions may be unique in that no two zones of an may have the same promotions. Users located within a zone may then receive promotions unique to their zone from the promotion system. Typically, users that are less likely to visit or make purchases at an establishment will be sent better promotions than those more likely to visit or make purchases. This is encourages users to visit and make purchases. The promotion system may comprise a promotion server or other data processing or computing device configured to receive promotions from establishments and distribute promotions to users' mobile devices based on the zone in which the user is located.

### CROSS-REFERENCE TO RELATED APPLICATION

This application claims priority to U.S. Provisional Patent Application No. 61/280,679, titled Mobile Casino Promotion Method and Apparatus, filed Nov. 6, 2009.

### FIELD OF THE INVENTION

The invention relates to promotions for gaming and other establishments and in particular to a multi-location promotion method and apparatus.

### RELATED ART

Promotional materials such as advertising, commercial offers, marketing materials, coupons, and the like are often used to promotion commercial establishments of various types. These materials may be costly to produce and distribute and often are simply ignored or discarded by their intended audience. Even where the materials are not ignored, it is often difficult to generate enough interest to sell a good or service.

From the discussion that follows, it will become apparent that the present invention addresses the deficiencies associated with the prior art while providing numerous additional advantages and benefits not contemplated or possible with prior art constructions.

### SUMMARY OF THE INVENTION

A multi-location promotion system provides unique promotions to users depending on their location. In one or more embodiments, the promotion system categorizes users according to zones and provides users at least one promotion based on the zone in which the users are located. This is highly advantageous in that it allows establishments to distribute different promotions to users based on their location. In this manner, the establishment may entice or encourage users that are less likely to visit or make purchases to come to the establishment.

The multi-location promotion system may have a variety of configurations. In one exemplary embodiment, the multi-location promotion system may comprise a server configured to receive one or more promotions from one or more establishments, each of the one or more promotions associated with one of a plurality of zones. It is noted that in this embodiment, the one or more promotions are unique from one another. The server may have an interface configured to accept the one or more promotions and to associate each of the one or more promotions to one of the plurality of zones. In addition, an access device configured to send one or more promotions created by the one or more establishments to the server may be provided.

The system may also include a wireless transceiver configured to receive a location of a mobile device and to communicate the location of the mobile device to the server. The server may then determine if the location of the mobile device is within one of the plurality of zones and send an associated promotion to the mobile device. The associated promotion will typically be one of the one or more promotions associated with the one of the plurality of zones containing the location of the mobile device. The wireless transceiver may be a cellular transceiver.

It is contemplated that one or more instructions configured to send the location of the mobile device to the wireless transceiver may be stored on a storage medium of the mobile device. It is noted that the one or more instructions may be configured to identify a triggering message from the wireless transceiver and, in response, send the location of the mobile device to the wireless transceiver.

The one or more promotions may be configured to entice or encourage users to visit or make purchases at an establishment. For instance, the one or more promotions may comprise one or more first discounts and one or more second discounts to one or more goods or services offered by the one or more establishments. The promotions having the first discounts may be associated with one or more of the plurality of zones that are one or more first distances away from the establishments. Likewise, the promotions having the second discounts may be associated with one or more of the plurality of zones that are one or more second distances away from the one or more establishments. The first discounts may be smaller than the second discounts, and the first distances smaller than the second discounts. In this manner, users that are further away from an establishment are provided better promotions to entice them to visit and make purchases.

In another exemplary embodiment, the multi-location promotion system may comprise a server having at least one processor in communication with at least one storage medium, zone information stored on the at least one storage medium defining at least a first and a second zone, and one or more promotions also stored on the at least one storage medium. At least one first promotion of the one or more promotions may be associated with the first zone, and at least one second promotion of the one or more promotions may be associated with the second zone. The processor may wirelessly send the at least one first promotion to one or more of the users located in the first zone and wirelessly send the at least one second promotion to one or more of the users located in the second zone.

The promotion system may include a mobile device as well. The mobile device may be configured to send a location of the mobile device to the processor which the processor may utilize to determine a location of the one or more users. The mobile device may be configured to receive a triggering message from the processor and, as a result, to send a location of the mobile device to the processor. Here, the processor may also utilize the location of the mobile device to determine the location of the one or more users.

As stated, the promotions may be distinct. For example, the at least one first promotion may provide a first discount and the at least one second promotion may provide a second discount. The first zone may be closer to an establishment than the second zone and the first discount may be less than the second discount. This may be used to entice users to visit and/or make purchases at an establishment.

In yet another exemplary embodiment, the multi-location promotion system may comprise at least one server in communication with at least one storage medium, zone information comprising a plurality of zones for one or more establishments stored on the at least one storage medium, and one or more promotions stored on the storage medium. Each of the one or more promotions may be associated with one of the plurality of zones.

The promotion system may also include at least one mobile device configured to determine a location of a user of the mobile device and to receive promotions from the server. The mobile device may be configured to present only one or more of the promotions associated with a zone of the plurality of zones which contains the location of the user.

Various methods for providing promotions with a multi-location promotion system are also disclosed herein. In one exemplary embodiment, the method may comprise receiving a plurality of zones comprising a first zone and a second zone from an establishment, and receiving a plurality of promotions comprising a first promotion and a second promotion from the establishment. The first promotion may be associated with the first zone and the second promotion may be associated with the second zone with the first promotion being distinct from the second promotion.

The method may also include storing the plurality of promotions on at least one storage device in communication with at least one promotion server, receiving a location of one or more mobile devices from at least one wireless transceiver, and sending the first promotion to one or more of the mobile devices in the first zone and sending the second promotion to one or more of the mobile devices in the second zone. The first promotion may comprise a first discount and the second promotion may comprise a second discount with the first discount being less than the second discount and the first zone being closer to the establishment than the second zone.

It is noted that a triggering message may be sent to the one or more mobile devices to cause the mobile devices to determine their location and send their location to the wireless transceiver. In addition, a request for the plurality of promotions may be received from the one or more mobile devices. The first promotion may then be sent to the one or more of the mobile devices in the first zone as a result of the request.

The multi-location promotion system and method may be used by a plurality of establishments. For example, at least one of the plurality of promotions and at least one of the plurality of zones may be received from one or more additional establishments.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram of an exemplary promotion system;

FIG. 2 is a block diagram of an exemplary gaming establishment utilizing an embodiment of the promotion system;

FIG. 3 is a perspective view of an exemplary gaming machine;

FIG. 4 is a block diagram of an exemplary promotion server;

FIG. 5 is a block diagram of an exemplary mobile device;

FIG. 6 is a flow diagram illustrating an exemplary sign up process for an embodiment of the promotion system;

FIG. 7 is a flow diagram illustrating an exemplary process for accessing promotions;

FIGS. 8A-8D are exemplary display screens illustrating an embodiment of the mobile device in use;

FIG. 9 is a flow diagram illustrating an exemplary multi-location promotion distribution process;

FIGS. 10A-10D illustrate exemplary zones of a multi-location promotion system; and

FIG. 11 is a block diagram of an exemplary multi-location promotion system.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The mobile promotion systems disclosed herein allow promotional materials from a variety of gaming or other establishments to be sent to and presented on a variety of mobile devices. The promotion system may be configured to suit the particular needs of gaming or other establishments related to mobile advertising or promotions. For instance, in gaming embodiments, the promotion system may be used in combination with player tracking systems to provide particular promotions to particular users. In other embodiments, the promotion system may be used in combination with an establishment's inventory tracking system to provide particular promotions to particular users.

In some embodiments, the promotion system may operate without the need for a central server or service. For example, the promotion system does not need a centralized server or service to aggregate and distribute promotions. In this manner, establishments may define and distribute promotional materials as they desire. In addition, there is no need for establishments to share information (with a central server or service) about users with a third party in order for the promotion system to function. In this manner, privacy is ensured. Also, establishments need not pay a third party providing a central server or service to distribute their promotions. Of course, the promotion system may utilize a central server if desired.

The promotion system also saves on marketing costs born by an establishment by reducing or eliminating the need for costly mailers. In addition, the promotion system provides instantaneous or near-instantaneous communication of promotional and other information with users. This allows time sensitive promotions to be made. For example, rather than delaying the start of a promotion or extending the time of a promotion, such as may be required with traditional mailed promotions, a promotion may begin at or near the time users are notified or informed of the promotion.

In addition, in gaming embodiments the promotion system may be configured to interact with player tracking systems and the like to allow users to redeem or take part in promotions. The promotion system may also be configured to track or monitor the redemption or use of promotions by users to thereby collect information regarding the success of one or more promotions, or lack thereof. Use of a player tracking system also allows customized or individualized promotions to be presented to users based on information about the user stored in the player tracking system.

Promotions associated with the promotion system may include offers or the like provided by an establishment. The promotions may also include advertising and other materials regarding goods or services provided by the establishment. Of course, other information may be provided as well. In general, the promotions will be designed to entice a user to come to the establishment, to play one or more wagering games, purchase the establishment's goods or services, or a combination thereof. As such, some of the promotions may require a user to take some action in order to redeem the promotion. For example, some promotions may require a user to play at least one wagering game or wager at least a particular amount.

A variety of promotions may be provided. For example, in one gaming embodiment, a promotion may include free credits or currency that a user may use to play one or more wagering games of a gaming establishment. In another embodiment, the promotion may include offers for complimentary or reduced priced lodging, drinks, and/or food. The promotion may also include offers for free or reduced priced goods or services. In yet another embodiment, the promotion may include free player points or increased player points if the user plays during a particular period of time (or, in some embodiments, anytime after the promotion is provided to the user). The promotion may also include increased winnings, activation of bonus games, providing one or more free spins, or the like in some embodiments.

Promotions may also increase the chances for a player to win one or more wagering games. For example, a player may be given better odds for winning as a result of a promotion. In one embodiment, a player taking advantage of a slot promotion may be given increased pay lines or wild symbols. In addition or alternatively, one or more slot symbols may be deemed wild by the promotion.

To convey meaning to a user, the promotions may comprise graphics, text, sound, video, animation, the like, or a combination thereof. As will be described further below, because the promotions may be displayed on a mobile device with a display screen, a promotion may be a multimedia or single media presentation in one or more embodiments.

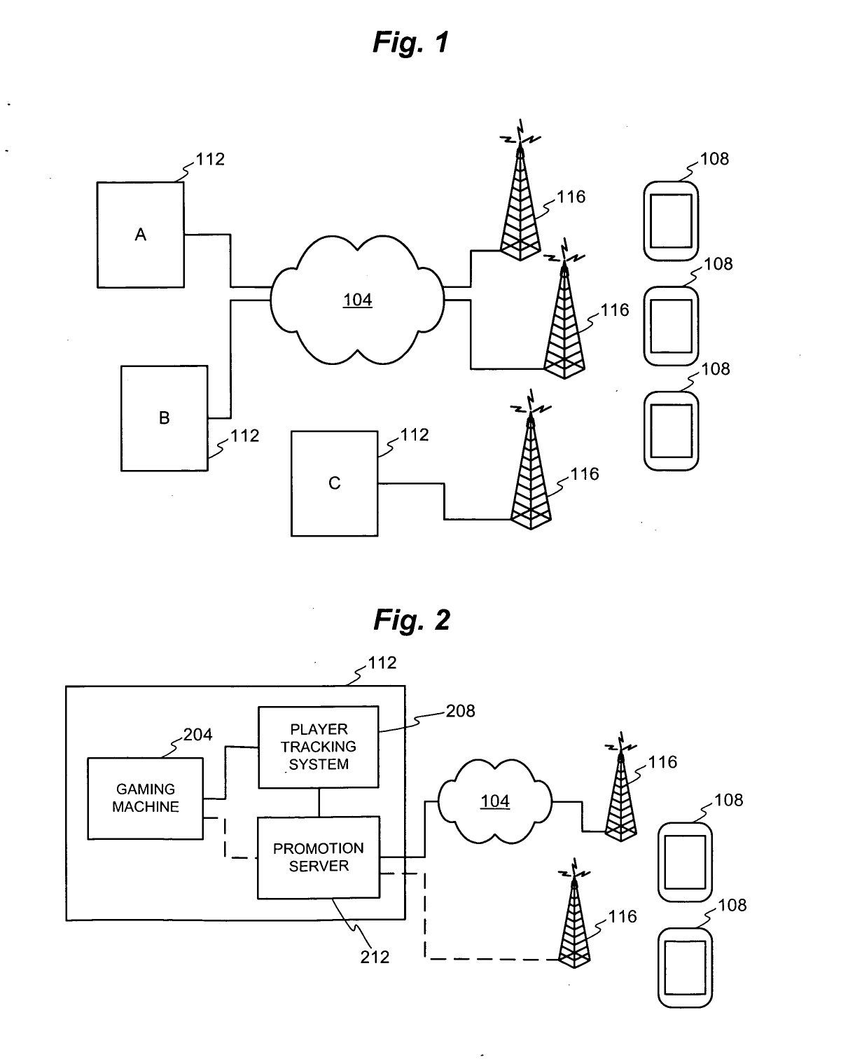

One embodiment of a promotion system in accordance with the invention will now be described with regard to FIG. 1. In general, the promotion system allows an establishment to distribute one or more promotions to users. In some embodiments, the promotion system allows customized promotions to be generated for individual users, such as by generating promotions based on information from a casino player tracking system. The promotion system may also store promotions and allow electronic redemption or participation in promotions or promotional offers in the promotions.

As shown, the promotion system comprises one or more establishments 112 that offer goods or services (e.g. stores, restaurants, casinos, etc. . . . ) for purchase and one or more mobile devices 108. The mobile devices 108 may be a variety of electronic handheld or portable devices capable of accessing and/or presenting promotions to users. Exemplary mobile devices include cell phones, smart phones, PDAs, netbooks, laptops, and the like. As will be described further below, the mobile devices may execute one or more applications to interact with the promotion system.

In one embodiment, the establishments 112 and mobile devices 108 may communicate through a network 104 and one or more wireless transceivers 116. It will be understood that one or more networks 104 may be used for communication with a wireless transceiver 116 as well. Alternatively, or in addition, a wireless transceiver 116 may be directly connected to the establishment 112 in some embodiments. This is illustrated by Establishment C in FIG. 1.

A wireless transceiver 116 allows promotions and related information to be communicated wirelessly between a mobile device 108 and an establishment 112. It is contemplated that the wireless transceiver 116 may be remote from or local to the establishment 112. For example, an establishment 112 may have a wireless transceiver 116 for use within its premises or area (i.e., a local transceiver), a wireless transceiver 116 for use remote from its premises or area (i.e., a remote transceiver), or both. It will be understood that the local and remote transceivers 116 may have overlapping coverage areas. In other words, either or both transceivers 116 may be used to communicate promotions within their coverage area.

In one embodiment, the local wireless transceiver 116 may be a local network transceiver, such as an 802.11a/b/g/n transceiver, for use at or within an establishment 112. In this manner, users at the establishment 112 may access promotions through the local transceiver. The remote wireless transceiver 116 may be a cellular transceiver or the like which is capable of a larger coverage area. In this manner, users at remote locations may access promotions through the remote transceiver. It will be understood that a variety of wireless communications protocols may be utilized. For example, wireless transceivers 116 may utilize 802.11a/b/g/n, WiMAX (trademark of the WiMAX Forum Corporation), EVDO, or any other protocol now known or later developed which is capable of providing access to the promotion system from a mobile device 108.

It is noted that a wireless transceiver 116 may be shared by one or more establishments 112 in some embodiments. For example, a single cellular transceiver 116 may be used by more than one establishment 112. For example, as shown, a plurality of establishments 112 may utilize the wireless transceivers attached to the network 104 in FIG. 1 (such a network 104 might comprise a cell network operated by companies such as Verizon, AT&T, etc.). It is contemplated that typically, but not always, remote transceivers may be shared while local transceivers will be used by their respective establishments 112.

As can be seen, an establishment 112 may send one or more promotions directly to a mobile device 108 without the need for a central server. To illustrate, in one embodiment, a promotion may be sent from the establishment 112 to a wireless transceiver 116 and from the wireless transceiver to a mobile device 108. This allows promotions to be “pushed” to a mobile device 108 at any time desired by the establishment 112. This is also beneficial in that the user does not need to specifically request promotions because the promotions may be pushed to the user's mobile device by the establishment 112. Alternatively, or in addition, it is contemplated that a mobile device may also be used to request promotions or download promotions (i.e., pull promotions) as desired by the user.

Various aspects of the promotion system will now be described. It is noted that though some embodiments relate to use by or in the gaming industry, the concepts disclosed herein may also be used with non-gaming establishments. This is generally because the promotion system may provide promotions for a variety of goods or services, including gaming and non-gaming goods or services.

FIG. 2 illustrates an example gaming embodiment where the promotion system is used with a gaming establishment 112. As can be seen, the gaming establishment 112 has at least one gaming machine 204 and at least one player tracking system 208. As will now be described, in general, the gaming machine 204 is configured to present one or more wagering games (i.e. games where value must be paid to play the game, such as a monetary wager, and wherein certain outcomes are defined as winning and have awards, such as awards of monetary value), the player tracking system 208 tracks or records player activity at gaming machines. It will be understood that player activity at other wagering games, such as pit games or sports book wagering, may also be tracked or recorded by the player tracking system and that this tracking information may be used by the promotion system herein.

FIG. 2 also illustrates how transfer of data that may occur with the promotion system. In one or more embodiments, a flow of data may occur to provide, redeem, and/or validate promotions. For example, a promotion server 212 or other computing device may provide a promotion to a mobile device 108. When redeemed, the mobile device 108 may communicate back with the promotion server 212. The promotion server 212 may communicate with the player tracking system 208 to retrieve or update player tracking information according to the redeemed promotion. In addition, communication may occur between the promotion server 212 and player tracking system 208 to validate user identities, retrieve player point or credit totals, and other player tracking information.

It is noted that redemption of a promotion may utilize communication between a gaming machine 204 and a promotion server 212 in one or more embodiments. For example, in one or more embodiments, the gaming machine 204 (or other equipment at the gaming establishment) may confirm the validity or authenticity of a promotion, a redemption attempt, user identity, or other information through communication with the promotion server 212. Of course, such validation or authentication may occur through additional communication with the player tracking system 208 by the promotion server 212, or may occur by direct communication with the player tracking system by the gaming machine 204 or other equipment.

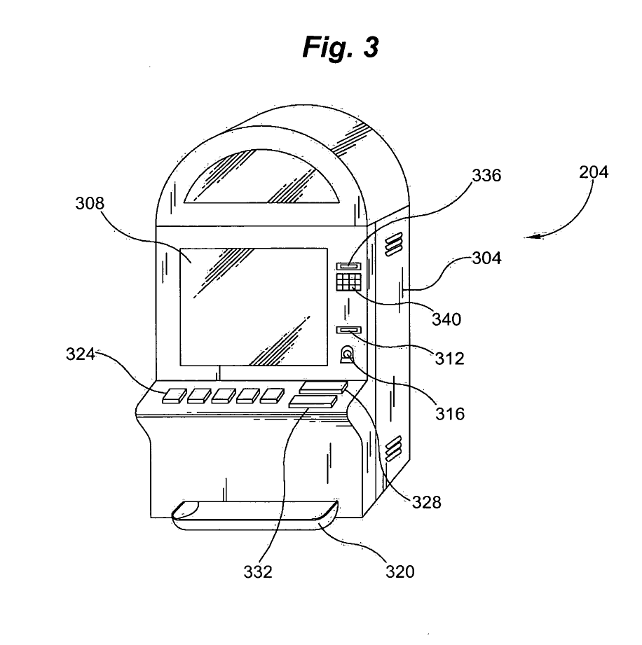

FIG. 3 illustrates an embodiment of a gaming machine 204 that may be used with the promotion system. As illustrated, the gaming machine 204 includes a housing 304 for enclosing/supporting various components of the gaming machine. The gaming machine 204 may include one or more display devices, such as a video display 308, for displaying game information. This information may comprise, as detailed below, images of cards or other indicia, and associated game information such as a paytable. Speakers (not shown) or other devices may be provided for generating sound associated with the game.

In one embodiment, the game is played as a wager-type game which requires that a player place a bet or wager to play the game. As illustrated, the gaming machine 204 may include one or more devices or means for accepting value, such as a bill validator/acceptor 312 for accepting paper currency and/or a coin acceptor 316 for accepting coins. Other means of accepting value for wagering, such as a credit card reader or a ticket reader, may be provided. Value provided to the gaming machine may be converted into credits. The player may wager some or all of this value/credits, such as by providing input regarding a wager (such as by pressing a “bet one” or “bet max” button, which effectuates placing a wager from the provided value).

Preferably, if the player is a winner of the game, then the player is provided an award. The award may be in the form of credits having associated monetary value. A player may “cash out” those credits into monies, such as bills or coins. An award of winnings in the form of coins may be paid to the player via a coin tray 320. Value may also be provided to the player by a printed receipt, a card or the like, as is well known in the art of “cashless” gaming.

Preferably, the gaming machine 204 includes means for a player to provide input. In one embodiment, this means comprises one or more buttons. For example, a plurality of card “hold” or “select” buttons 324 may be provided for permitting a player to hold/select cards in a hand of a card game. A deal/draw button 328 permits a player to indicate that they wish the game to start or to draw replacement cards. A bet button 332 is provided for a player to select the amount to bet on a particular game. Other or additional types of input devices may be utilized, such as a touch-screen, joystick, rotating arm or the like, such as for implementing other types of games including slot games.

The gaming machine 204 may also include a player tracking module comprising a reader 336 and/or a keypad 340 for collecting user input. The reader 336 may be a card reader, such as a magnetic stripe reader, to read player tracking cards. Of course, the reader 336 may also or alternatively be configured as a wireless device, such as an RFID transceiver or the like. The reader 336 may also be a barcode scanner in some embodiments. It is contemplated that the keypad 340 may be used to input player tracking identification to identify a player. In this manner, a player need not present his or her player tracking card or the like to the gaming machine. Rather, the player may input identification information into the keypad to identify him or herself for player tracking and awards.

The reader 336, keypad 340, or both may also be used to collect or communicate other information. For example, as will be described further below, the reader 336, keypad 340, or both may be used to redeem or take part in one or more promotions or promotional offers provided by the promotion system as described herein.

A game controller (not shown) is provided for controlling the various devices of the gaming machine and for providing game information. For example, the game controller may be arranged to generate video and audio data for presentation by the display 308 and speakers of the gaming machine 204. The game controller may be arranged to detect a signal from the coin acceptor indicating the receipt of coins or other value, and may be arranged to cause a coin delivery mechanism to deliver coins from a coin hopper to the coin tray 320, or otherwise credit or dispense winnings. The controller may also be configured to detect the placing of a wager and then present a game in response thereto. The game controller may be configured to accept game data generated at a remote location, such as a remote server, and effect presentation of a game using that data.

In one or more embodiments, the game controller may execute one or more instructions, programs, software modules, or the like to control various devices of the gaming machine or to provide game information. The one or more instructions, programs, software modules, or the like may be stored on a storage medium (such might comprise a data storage or memory device such as ROM, RAM, a hard drive or the like) within or accessible by the game controller. The instructions may comprise, for example, machine readable code configured to affect the steps/features of the game play/presentation methods detailed herein.

The game controller may include a random number generator or the gaming device may include a separate random number generator or be in communication with one in some embodiments. The random number generator may be a device within the controller used to generate random game results or outcomes. The random number generator may be configured to provide one or more random numbers to facilitate the play of one or more games. As is known, random numbers are commonly used in wagering games to provide an outcome of a game.

The random number generator may accept one or more seed values in one or more embodiments from which one or more random numbers may be generated. The seed value may represent various tangible objects or characteristics. For example, a measurement of vibration, temperature, voltage, or time may be used as a seed value. It is noted that the random number generator may include or be connected to one or more sensors or the like to measure these or other values for use as seed values. It is also noted that in server based gaming environments, the random number generator may be remote from one or more gaming machines and that the random numbers generated by the random number generator may be communicated to the gaming machines and/or that game outcomes may be provided to the gaming machine.

It will be appreciated that the gaming machine 204 may have a variety of configurations and the gaming machine 204 illustrated and described above is but an example of a device for use with the promotion system. For example, the gaming machine 204 may include one or more rotating reels, as is common to “slot”-type machines. The gaming machine 204 may be associated with a network and receive game information remotely and may transmit information, such as payout and game play information, to a remote location. Such a network may include one or more wireless or wired communication links.

The gaming machine 204 may also have other forms than that illustrated. For example, the gaming machine 204 might comprise a computing device, such as a home computer. The home computer may be configured to receive game information over the Internet or other communication link to a game server. The gaming machine 204 might also comprise a hand-held device such as a mobile telephone or PDA. The gaming machine 204 may also be a “server” based gaming device. Such a device may comprise a thin-client which has a controller, but wherein game results and the like are generated at a server and transmitted to the gaming machine for display.

Referring back to FIG. 2, a player tracking system 208 may be in communication with one or more gaming machines 204 to collect game play information. As can be seen, the player tracking system 208 and gaming machine 204 are in communication to facilitate the collection of the game play information. It will be understood that the player tracking system may include one or more devices such as one or more servers, storage devices, or both for the purposes of tracking player activities.

Tracking information generally includes information regarding the play of wagering games. For instance, amounts wagered, side bets, player winnings, player losses, the like, or a combination thereof may be collected as tracking information. In addition, player input during one or more wagering games may also be collected. Game play information may also include the type or configuration of the wagering game(s) played by a player. A player may be awarded rewards or loyalty points and thus the game play information may include the number of player points a player has accumulated through his or her gaming or other activities (as is known in the art of casino loyalty programs, such points may be redeemed for free game play, cash, prizes or the like). The game play information may be stored by the player tracking system 208 in one or more embodiments.

The player tracking system 208 may store player information as well. In general, player information is used to identify a particular player. For example, a player's name, address or other contact information and the like may be part of the player information. Other player information such as social security numbers, birthdates, and anniversary dates for a user may also be stored. The player tracking system 208 may assign an identifier to a user or player that uniquely identifies the user or player. For example, a player may be assigned a player tracking number or the like.

In addition, player information may also include a user's preferences for goods or services provided by a gaming establishment. For example, a user's favorite or preferred wagering games, meals, beverages, hotel room preferences, and the like may be stored in the player information.

In one embodiment, the player's game play information may be associated with player information. In this manner, tracked game play information may be tied to or identified with a particular player. As will be described further below, the tracking information and player information may then be used to provide promotions, such as targeted promotions, via the promotion system. In one embodiment, the player information, game play information, or both may be stored in the player tracking system as one or more player tracking accounts. For example, individual files or accounts may be created for individual players and their tracked game play data may be associated with such files or accounts.

As used herein, the term “game play” information is not limited to information regarding wagering game play. For example, some casinos track other activities of players such as the patronage at restaurants, stays at associated hotels and the like. Information regarding such activities may also be tracked and tied to the player.

In addition to gaming machines 204 and a player tracking system 208, a gaming establishment 112 may have one or more promotion servers 212. In one or more embodiments, a promotion server 212 may be configured generate, store, collect, and/or distribute one or more promotions. The promotion server 212 may also access or utilize the tracking information and/or player information in performing these functions.

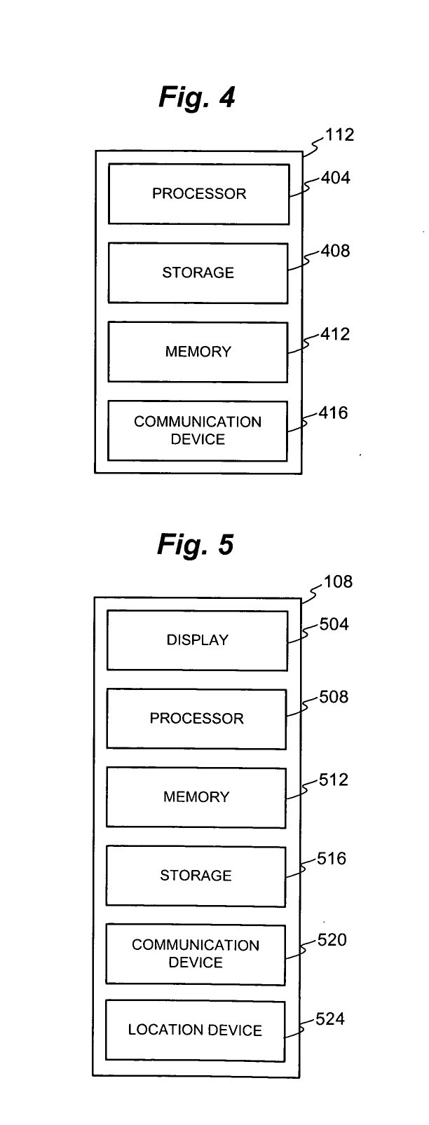

FIG. 4 illustrates an exemplary promotion server 212. In one or more embodiments, the promotion server 212 may distribute promotions to mobile devices 108, such as through a wireless transceiver. The promotion server 212 may also receive and store promotions from an establishment for subsequent distribution to mobile devices. In some embodiments, the promotion server 212 may additionally track usage or redemption of promotions. In this manner, promotions that are more successful may be identified from promotions that are less successful. It is noted that though referred to herein as a server, the promotion server 212 may be a variety of data processing devices, computing devices, or the like configured to provide the functionality described herein.

As can be seen, the promotion server 212 may comprise one or more processors 404, storage devices 408, memory devices 412, communication devices 416, or a combination thereof. In one or more embodiments, a processor 404 may be configured to execute one or more instructions, such as in the form of machine readable code, in order to perform the functions of a promotion server 212. The instructions may be hard wired into the processor 404 itself or be retrievably stored on a memory device 412 or storage device 408 of the promotion server 212. In general, the instructions will be configured such that, when executed, the promotion server 212 will perform its function as described herein. It is noted that the memory device 412, which may be RAM or ROM memory in one or more embodiments, may be accessed or otherwise used by the processor 404 when executing the instructions. In one or more embodiments, the memory device 412 may be used as temporary storage while the storage device 408 is used as more permanent or as persistent storage.

In addition to or instead of storing the instructions, a storage device 408 may also store the promotions of the promotion system. For example, the storage device 408 may store text, audio, video, animations, and/or graphics that make up the promotions. These elements of the promotions may be stored separately or as a combined data file. The elements may also be stored in a database in one or more embodiments. It will be understood that the storage device 408 may be remote from the promotion system and accessible to the promotion server via a network or the like in some embodiments.

A promotion may comprise various data. For example, in one embodiment, a promotion may comprise one or more of the following data:
Title—the name or title of the promotion
Start Date/Time—an optional start date and/or time for the promotion
Expiration Date/Time—an expiration date and/or time for the promotion
Description—a description of the promotion (e.g., the promotion's benefits or offers)
Image(s)—one or more images related to the promotion
Video(s)—one or more videos related to the promotion
Sounds(s)—one or more sounds related to the promotion
Requirements or Terms—prerequisites required before a promotion may be redeemed and terms of the promotion
Instruction(s)—machine readable commands or parameters which allow the promotion to be redeemed at gaming machines, player tracking systems, or other equipment

It will be understood that though the Start Date has been listed as optional, other data may not always be included (i.e., may be optional) as well. For example, a promotion need not always include an image, sound, or video in one or more embodiments.

In one or more embodiments, promotions may be stored in a database or as one or more files according to a file format. For example, a promotion may be defined by HTML, Flash (trademark of Adobe Systems Incorporated), XML, or other formats. Though stored in one format, it is contemplated that the promotion server may convert the promotions to another format for transmission to mobile devices. In this manner, a variety of mobile devices may be used.

In one embodiment, as will be described further below, the mobile devices may utilize a common file or data format. In this manner, the promotions may be sent in the same format regardless of what type of mobile device is receiving the promotion. This is advantageous in that the promotion server need not track and convert promotions based on the type of mobile device the server is communicating with.

It is contemplated that some or all of a promotion may be sent to a mobile device in one or more embodiments. For example, in some embodiments, only the data necessary to properly display the promotion on a mobile device is sent. To illustrate, everything but the instructions of the promotion may be sent to a mobile device. In this manner, the promotion may be displayed without the need to transmit data that will go unused. Because the promotion server stores the promotions, additional data of the promotion may be accessed as desired from the promotion server. For example, when the above instructions are needed, such as during redemption of the promotion, the instructions may be retrieved from the promotion server by the mobile device, gaming machine, player tracking system, or other equipment.

The promotion server 212 may communicate with one or more external devices through one or more communication devices 416 in one or more embodiments. For example, as shown in FIG. 2, the communication devices 416 may be used to communicate tracking information, player information, or other information with a player tracking system 208. In addition, the communications devices 416 may be used to communicate with a wireless transceiver 116 for wireless communication with one or more mobile devices 108. For example, the communication devices 416 may comprise a communication interface to an external network, such as a network which links to the wireless transceiver 116.

In operation, the promotion server 212 may receive one or more promotions from an establishment 112. For example, the establishment 112 may create a promotion and upload it to the promotion server 212. It is contemplated that promotions may be created on the promotion server 212 in one or more embodiments.

The promotion server 212 may provide various options for distributing promotions. For example, promotions may be distributed immediately upon their receipt or creation. Alternatively, distribution may be scheduled on the promotion server 212. For example, one or more promotions may be scheduled for distribution to mobile devices at a particular time or date, such as on their start date and/or time. In addition, distribution may occur as the result of a triggering event. For example, the promotion server 212 may track a user's accumulated player points or wagering activity. Once the points or wagers reach a particular threshold, the promotion server 212 may be configured to automatically distribute one or more promotions to the user as specified by the gaming establishment 112.

In one embodiment, promotions may be triggered or generated based upon certain player tracking criteria or information. For example, a promotion may be created where players qualify if they have not engaged in game play for a certain period of time. The promotion server 212 may communicate with the player tracking system 208 to verify such eligibility. For example, the promotion server 212 may communicate with the player tracking system 208 to determine the last time the user played a wagering game. It is noted that either or both the player tracking system 208 or the promotion system 208 may check the player tracking information for one or more triggers that would cause a promotion to be generated and/or sent to one or more users.

A mobile device 108 will now be described with regard to FIG. 5. As can be seen, the mobile device 108 may comprise one or more displays 504, processors 508, memory devices 512, storage devices 516, communication devices 520, and one or more location devices 524. It will be understood that various embodiments of mobile devices 108 may have additional components or fewer components. For example, location devices 524 may not be provided in some embodiments. In addition, some components may perform the function of one or more other components. For example, a memory device 512 may be used instead of a storage device 516 and vice versa, or a communication device 520 may be used to determine location. In these embodiments, components providing redundant functionality may not be provided.

In one or more embodiments, a processor 508 may be configured to execute one or more instructions, such as in the form of machine readable code or software, to allow a mobile device 108 to perform its functions. The instructions may be hard wired into the processor 508 itself or be retrievably stored on a memory device 512 or storage device 516 of the mobile device 108. In general, the instructions will be configured such that, when executed, the promotion server 108 will perform its functions as described herein. It is noted that the memory device 512, which may be RAM or ROM memory in one or more embodiments, may be accessed or otherwise used by the processor 508 when executing the instructions. In one or more embodiments, the memory device 512 may be used as temporary storage while the storage device is used as more permanent or as persistent storage.

In addition or instead of storing the instructions, a storage device 516 may also store the promotions of the promotion system. For example, the storage device 516 may store text, audio, video, animations, and/or graphics that make up the promotions. These elements of the promotions may be stored separately or as a combined data file. The elements may also be stored in a database in one or more embodiments.

A display 504 may be provided to display or present the promotions. The display 504 may be an electronic display screen, such as an LCD, OLED, or other screen, to permit display of a variety of text, video, animations and/or graphics that may be part of a promotion. In addition, the display 504 may be used to present redemption information. For example, the display 504 may present a barcode or other machine scannable/readable identifier. In this manner, the display 504 may be read by a gaming machine (or other device) to allow the user to easily redeem or take part in a promotion. The display 504 may also display a code or other identifier that the user may manually enter to redeem or take part in a promotion. Also, the display 504 may be used to provide information related to promotions such as terms, requirements, descriptions, and expiration dates of one or more promotions.

The display 504 may be touch sensitive in one or more embodiments to collect input from a user. Of course, the mobile device 108 may include one or more user inputs such as buttons and the like to collect user input as well. In addition, it is contemplated that the mobile device 108 may include audio or visual inputs as well. For example, the mobile device 108 may include a microphone and/or camera to capture audio and images. The captured audio or images may be interpreted by the mobile device 108 as commands (e.g., voice/image recognition), and when recognized, the mobile device may perform certain functions.

In one or more embodiments, the mobile device 108 may comprise a location device 524. In general the location device 524 is configured to determine the location of the mobile device 108. For example, the location device 524 may be a GPS receiver capable of determining the longitude and latitude of the mobile device 108. Of course other devices may be used to determine location. For example, a communication device 520 (as will be described further below) may be used to determine location such as by determining the mobile device's 108 distance from one or more wireless transceivers having known locations. It is noted that location may be determined in other ways as well. For example, in one embodiment, the mobile device 108 may request information identifying its location from its user, such as in the form of a zip code, address, building, latitude, longitude, or the like.

The location device 524 may be used to provide specific features of the promotion system. For example, with the location device 524 promotions for a particular area surrounding the user's current location may be easily retrieved by the user's mobile device. In addition, the mobile device may use the location device to identify and present promotions for establishments near or at the user's current location.

In one embodiment, the location device 524 may be used to determine whether the user is at or in an establishment. Special promotions, which would otherwise be unavailable or hidden if the user were not at the establishment, could then be made visible or accessible to the user. Alternatively, some promotions may be visible but deactivated (i.e., not redeemable) unless the user is in a particular establishment. Upon determining the user is at the particular establishment, the mobile device may activate these promotions. These features are highly advantageous in that they entice user to visit the establishment.

The communication device 520 of the mobile device 108 will typically be a wireless communication device 520 for communication with one or more wireless transceivers such as described above. The communication device 520 may utilize a variety of wireless communications protocols to communicate data of various types between the mobile device 108 and a wireless transceiver. It is contemplated that multiple wireless communications protocols may be used by a single mobile device. For example, a mobile device 108 may communicate via Bluetooth (trademark of Bluetooth SIG) or 802.11a/b/g/n as well as EVDO or WiMAX.

Wireless communication may also occur between the mobile device 108 and other devices. For example, the mobile device may communicate with other mobile devices to share promotions. In addition, the mobile device may communicate with a gaming machine, player tracking system, or the promotion server to redeem or access promotions. In one embodiment, for example, a short range wireless connection, such as Bluetooth, may be used to redeem promotions at gaming machines.

The mobile device 108 may include additional communications devices 520 as well. For example, the mobile device 108 may include wired communications devices 320 such as a wired network interface, optical interface, or a USB interface, or other wired data interface. It is contemplated that wired communications devices and wireless communication devices may be used for the same data communication, or that one type of communication device may be reserved for particular types of communication. For example, syncing or software updates may occur over a wireless connection, while other communications occur wirelessly.

The mobile device 108 might comprise one or more existing mobile devices such as an Apple iPhone (trademark of Apple Inc.), Blackberry (trademark of Research in Motion Limited) or the like.

One aspect of the promotion system is a method of using a mobile device to receive and/or use gaming establishment promotions. One such method will now be described. Though the steps of the process are described in a particular order, it will be understood that one or more of the steps may be occur in various orders, and that some steps may be omitted in some embodiments.

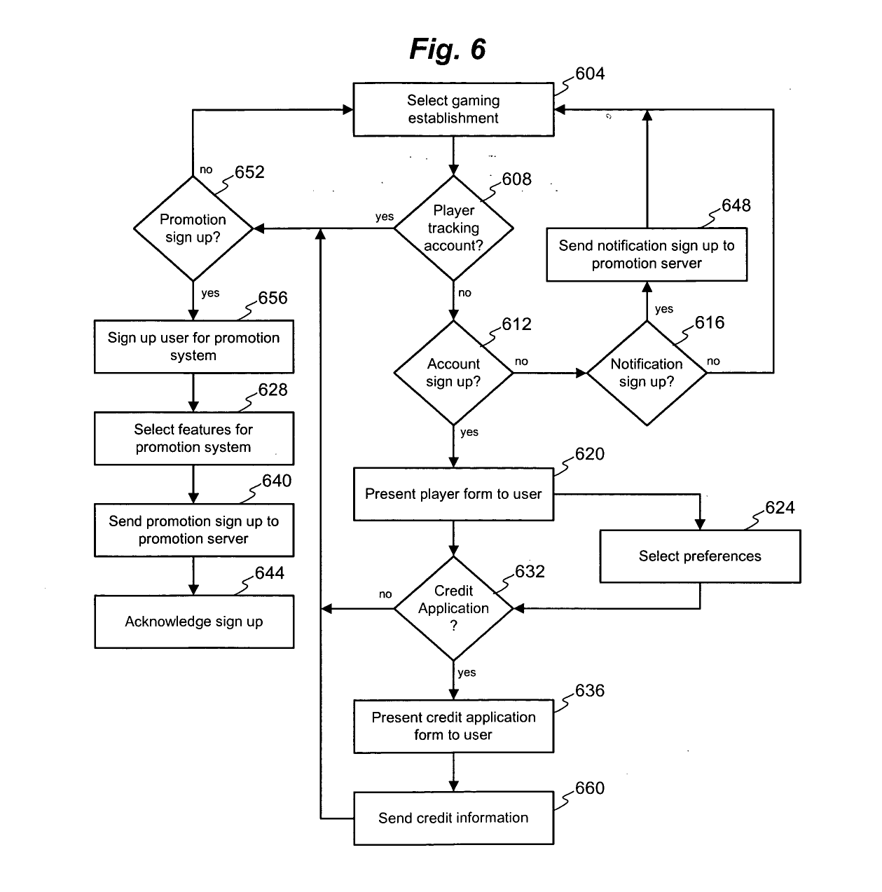

FIG. 6 is a flow diagram illustrating the sign up processes at a mobile device, where a user signs up to receive promotions from the promotion system. As will become apparent from the discussion below, the sign up process may take into account whether or not the user has a player tracking account or is a member of a gaming establishment's loyalty program. For instance, the sign up process may include signing up the user with a player tracking system (i.e., creating a player tracking account) in some embodiments. This allows promotions to be associated with a user's player tracking account in one or more embodiments. The association is beneficial because at least some of the promotions may be tied to a user's player points or other tracked gaming activity. It is noted that alternatively, a user may sign up for the promotion system only in some embodiments of the promotion system.

In general, signing up to receive promotions from the promotion system occurs by a user providing contact information where one or more promotions may be sent. This may be a phone number, email address, or other identifier of the user's mobile device. Alternatively or in addition, sign up may include the user providing identifying information or player information to allow the promotions to be based on the user's player tracking information. For example, the user may provide a player tracking number or other player tracking account information to link to the player tracking information. Sign up may also include specifying particular promotions or types of promotions that the user is interested in.

In one or more embodiments, the signup process may occur at a mobile device. For instance, the mobile device may have a promotion application or software that allows users to sign up for one or more promotions according to the sign up process. The software may comprise one or more instructions stored on a storage device or memory device of the mobile device. It is contemplated that the software may be preinstalled on the mobile device or may be downloaded or otherwise obtained and then installed on the mobile device. The software may also be used to interact with the promotion system, redeem promotions, or both in one or more embodiments. In other embodiments, the sign up process may be completed manually, such as in-person by the player at an establishment.

FIG. 6 is a flow diagram illustrating an exemplary sign up process for the promotion system via the user's mobile device. At a step 604, a user may select a gaming establishment he or she is interested in. This may occur in a variety of ways. In one embodiment, the user may be presented with a selection of establishments, and be permitted to select one or more of the establishments to receive promotions for. In another embodiment, the user may input a gaming establishment's name to select the establishment. In yet another embodiment, the mobile device may select the gaming establishment. For example, the mobile device may utilize its location device to determine if the user is near or at a particular gaming establishment and, if so, the mobile device may automatically select the particular gaming establishment. It will be understood that any method of selecting one or more gaming establishments may be used. For example, a gaming establishment may be randomly selected in some situations.

Once a gaming establishment has been selected, it may be determined at a decision step 608 if the user is already signed up with a player tracking system of the gaming establishment (i.e., the user has a player tracking account). This may be accomplished by collecting player information, tracking information, a player tracking number, username and password, or the like to verify that a user has a player tracking account. Of course, other information may be collected as well to make this verification.

If the user is already signed up, then the user may be given the option to sign up for the promotion system at a decision step 652. If the user decides to sign up for the promotion system, then the sign up process may begin at a step 656. Because, the user already has a player tracking account, the player information comprising information identifying the user is already available to the promotion system. In addition, the user's contact information may already be available to the promotion system. Thus, this information need not be collected again during the sign up process at step 656.

Of course, this and other information may be collected at step 656 if necessary or desired. For example, the player tracking system may not have all the information the promotion system needs to function. In one or more embodiments, the user may be presented with player and/or contact information and be requested to confirm the accuracy of the same.

It is noted that the user's contact information may be any identifier capable of identifying the user, the user's mobile device, or both. In this manner, the contact information may be used by the promotion system to distribute promotions to a particular user or mobile device. The identifier may be assigned to the mobile device or user by the promotion system, or the user may utilize a preexisting identifier such as a phone number or email address.

As part of the sign up process, the user may be required to agree to terms of the promotion system and/or to receive promotions. Once the sign up process is complete, the user may be allowed to select one or more features of the promotion system at a step 628. In one or more embodiments, a menu of features may be presented at step 628 for selection by the user. In general, the features will be features of the promotion system that may be activated or deactivated or otherwise configured. For example, the menu may present selections such as “Advise me of gaming promotions”, “Track my play and point benefits”, “Automatic notification when user enters gaming establishment (for instant rewards)”, “Allow mobile device to identify user at slot machines and to pit and sports personnel, parking valets, restaurants, etc. . . . ” The user may then select each of the features that he or she wishes to activate or deactivate.

It is contemplated that the user may also be permitted to select or configure preferences for the operation of the promotion system on his or her mobile device. For example, the user may activate, deactivate, or configure various alerts or notifications regarding the user's promotions. In one embodiment, the user may activate an alert that occurs when the mobile device receives a new promotion. Alerts may also be activated when a promotion is nearing expiration or is expired. The user may also set up alerts only for certain types of promotions or promotions only at particular gaming establishments. Of course, various other criteria may be utilized as well in setting up alerts.

At a step 640, the user's sign up information, such as the user's player tracking information, contact information, or both, may be sent to a promotion server. At a step 644, an acknowledgment may be provided to the user by the promotion server that confirms the user's sign up for the promotion system. In one embodiment, the acknowledgment indicates to the user that his or her information has been received and that the user has been signed up with the promotion system. If an error occurs, the user may also be notified of the same and may be provided instructions on how to successfully sign up. The user may then receive one or more promotions and interact with the promotion system.

Referring back to decision step 608, if the user does not have a player tracking account, it may be determined at a decision step 612 whether or not the user wishes to sign up for a player tracking account at the selected gaming establishment. If the user does not wish to sign up, the user may be given the option to be notified of promotions at a decision step 616.

Notification is beneficial in that it allows the user to see the kinds of promotions that are available. However, in some embodiments, the user may not be permitted to redeem or take part in promotions until he or she has signed up. In this manner, the user is encouraged to sign up with the promotion system.

If the user desires notifications, the mobile device may communicate this to a promotion server. Contact information may also be communicated to the promotion server to allow the promotion server to send notifications to the user. For example, the mobile device may provide an email address, phone number, username or other identifier to the promotion server. This contact information may then be used to notify the user of one or more promotions.

At a step 648, the mobile device may send the contact information and/or notify the promotion server that notifications are desired. If necessary, the mobile device may also collect contact information from the user. This is not always necessary because the mobile device may already contain contact information for the user or the mobile device. In these cases, the contact information may automatically be sent without first querying the user. For example, a phone number or email may be sent to the promotion server automatically. Once the information is sent to the promotion server at step 648, the mobile device may return to step 604 where a gaming establishment may be selected. Likewise, if the user does not desire notifications at decision step 616, the mobile device may also return to step 604 to allow the user to select a gaming establishment.

Referring back to decision step 612, if the user decides to sign up for a player tracking account, the method may continue at a step 620 where a player form is presented to the user by the mobile device. In general, the player form is configured to collect information from the player. In one embodiment, the player form collects player information that identifies the user, such as one or more names, addresses, phone numbers, and the like. The player information may also include identifying information such as social security numbers, birthdates, anniversary dates, and other information about the player.

Optionally, once player information has been collected, one or more user preferences may be collected at a step 624. For example, the user's hotel preferences (e.g., bed sizes, smoking or non-smoking, requirement for handicap facilities) may be collected via the mobile device. Of course other preferences may be collected as well. For example, drink or food preferences and gaming interests may be collected. In one embodiment, the mobile device may collect the player's preferred or favorite wagering game or games (e.g., slots, pit games, sports betting).

At a decision step 632, the user may be presented with an option to apply for a line of credit. If so desired, the user may be presented a credit application form at step 636. The credit application form may collect additional information from the user and may utilize information previously collected or available on the mobile device. For example, the user's name and address may have been previously collected on the player form and thus would not need to be collected again. Credit information that may be collected includes information regarding the user's income, work history, residence, citizenship, and other information relevant to establishing a line of credit. The credit application form may also collect an authorization to check the user's credit score or the like in one or more embodiments.

Once the credit application form is filled in, the player information collected via the player form, the credit information collected via the credit application form, or both may be sent to a player tracking system at a step 660. Of course, the player information and credit information may be sent to various systems or devices. For example, the credit information may be sent to a credit server or service while player information is sent to the player tracking system or service. Once the player tracking system receives the player information, the user's player tracking account may be established.

Because elements of the promotion system may be in communication, it will be understood that the player, credit, tracking, contact, or other information may be shared amongst the elements of the promotion system. For example, player, contact, or tracking information may be shared with a promotion server via a player tracking system. Likewise, promotion tracking or usage information may be shared with a player tracking system via a promotion server.

After the player tracking account has been established, the user may have the option of signing up for the promotion system at decision step 652. As described above, if the user declines to sign up for the promotion system, the method may return to step 604 where another gaming establishment (or the same establishment) may be selected. If the user desires to sign up for promotions, this may occur at step 656 as described above. The user may then be permitted to select one or more features at step 628. Once this is complete, the sign up information and feature selections/configurations may be sent at step 640 and acknowledged at step 644. As stated above, the sign up information and feature selections/configurations may be sent and acknowledged by a promotion server. After signing up the user may interact with the promotion system as well as receive and redeem or take part in one or more promotions provided by the promotion system.

As can be seen, the sign up process is advantageous in that it may be performed on a mobile device, regardless of where the mobile device is located. In addition, the mobile device is capable of providing sign up forms (e.g., player forms and credit application forms) for different gaming establishments. Because the promotion system does not require a centralized server, it is contemplated that individual gaming establishments may provide their own forms. For example, a promotion or other server at gaming establishment A may provide establishment A's forms, while another promotion server provides forms for another establishment. In this manner, each gaming establishment may configure its own forms and collect the information it desires. In these embodiments, the mobile device may be configured to retrieve one or more forms from a selected establishment prior to presentation of the form to a user.

The embodiment of FIG. 6 generally requires a user to have a player tracking account prior to allowing the user to sign up for promotions. This is advantageous in that it encourages users to sign up for a player tracking account in order to receive benefits provided by the promotions. In addition, a user with a tracking account may be provided customized or individualized promotions based on his or her tracked gaming activity or other activity. In this manner, promotions may be targeted to the user to increase usage or redemption of promotions by the user. This in turn provides benefits to the gaming establishment because the user is enticed to utilize goods or services of the establishment.

Despite these advantages, it is contemplated that a user may sign up for the promotion system without having a player tracking account in some embodiments. For example, a user may select an establishment on his or her mobile device, and provide the selected establishment with sign up information such as contact information. Optionally, the user may be permitted to select or configure one or more features of the promotion system. As described above, the sign up information and any feature selections/configurations may be sent from the mobile device to a promotion server to sign the user up for promotions. An acknowledgment, as described above, may be provided as well. Of course, in this embodiment, such acknowledgement would not include player tracking information.

Sign up without a player tracking account is beneficial in that it allows users to more easily sign up for promotions. Thus the promotions and promotion system may be utilized by a wider audience to bring in additional customers to a gaming establishment.

Users may sign up in various other ways. For example, a user may “sign up” for promotions simply by installing a client application or software on his or her mobile device. When executed, the software may receive promotions from the promotion system. It is noted that, sign up need not be required in all embodiments because users may access the promotion system without first signing up.

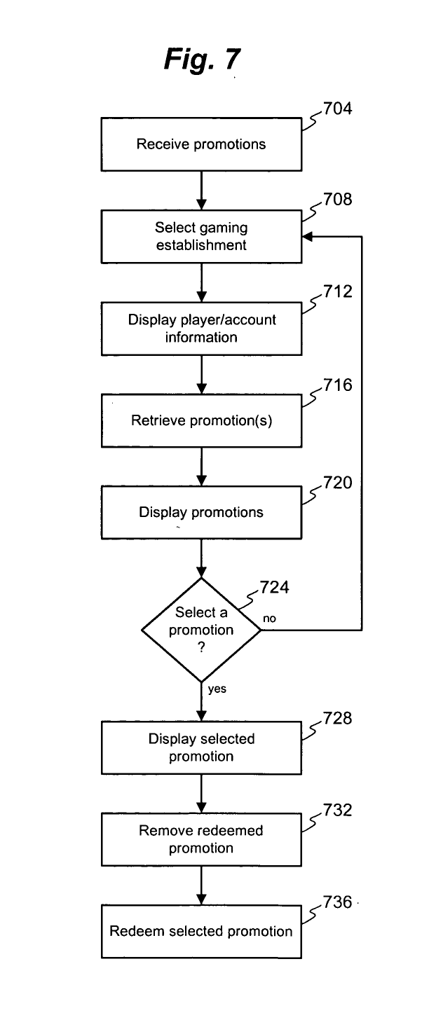

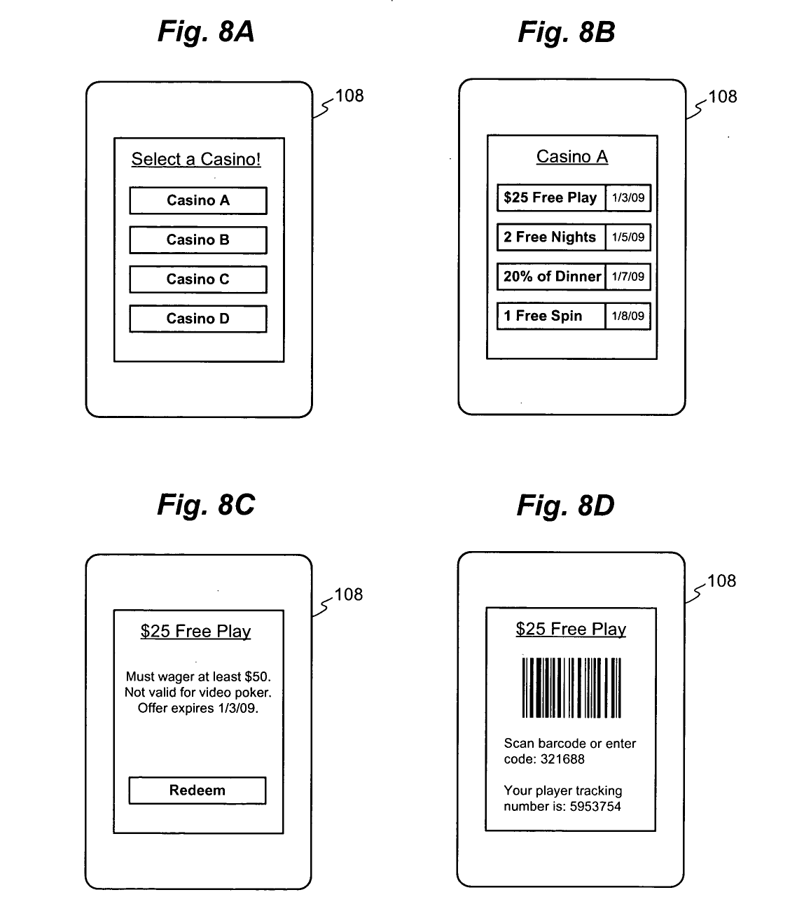

Once the user has signed up for the promotion system and/or any necessary promotion application or software is installed on the user's mobile device, he or she may receive one or more promotions, view promotions, or redeem or take part in promotions. Such interaction with promotions is illustrated in FIGS. 7 and 8A-8D. FIG. 7 is a flow diagram illustrating steps involved in viewing and redeeming promotions according to one embodiment of the promotion system. FIGS. 8A-8D illustrate exemplary displays that may be presented to a user by the mobile device during viewing and redemption of promotions. The mobile device may execute an application or software to provide these displays and to provide promotion viewing and redemption functionality. In addition, the application or software may be configured to receive promotions.

At a step 704, at least one promotion may be received by the mobile device. Typically, the promotion will be received wirelessly via a wireless transceiver, such as described above. As stated, promotions may be “pushed” to the mobile device. In this manner, promotions need not be retrieved or requested by the mobile device (though they may be). In this manner, the promotions may be sent to the phone and automatically received and/or stored. The promotions may then be viewed immediately or viewed later. This functionality is beneficial in that available promotions may be instantaneously viewable and accessible by a user. In addition, a user may be alerted to new promotions as they are sent to the user's mobile device by a gaming establishment. In this manner, there is an increased sense of excitement as new promotions arrive.

Moreover, this capability allows time sensitive promotions to be better used. For example, a promotion having various limited or predetermined times of availability or validity (such as 4 or fewer hours for example) before its expiration may be pushed to the user's mobile device. Because the user is alerted, it is more likely that the user will be aware of the promotion and take part in it. These promotions may have superior offers or terms since their time of availability may be very limited. Without push functionality, the user could easily miss these promotions (if the user must “pull” the promotions, if the user does not request promotions frequently, the user can entirely miss promotions which are intended for them; further, the “pull” configuration requires that the user interrupt their activities and request information, whereas the “push” configuration causes the promotional information to reach the user's mobile device without any interference to the user).

As stated, in some embodiments, promotions may also or alternatively be retrieved by the mobile device rather than being pushed to the mobile device. For example, a user may initiate a process at the mobile device to download or otherwise retrieve available promotions from the promotion server. In one or more embodiments, this may occur by the user activating a “Refresh” or “Reload” button, or the like.

It is contemplated that a user may be provided with an option to immediately view new promotions as they arrive on the mobile device. For example, a “View New Promotion(s)” button or the like may be provided upon receipt of a new promotion to view the promotion. Alternatively, some or all promotions that have not been previously viewed by the user may be presented. In other embodiments, it is contemplated that promotions may be presented in an organized manner. Of course, received promotions need not be viewed immediately. The mobile device may be configured to store promotions so that they may be viewed at any time after their receipt.

At a step 708, the user may view promotions for one or more particular gaming establishments by selecting the establishment(s) he or she desires. In one embodiment, the user may be presented a menu or list of gaming establishments to choose from, such as shown in FIG. 8A. When at least one gaming establishment has been selected, it is contemplated that information specific to the gaming establishment may be optionally displayed at a step 712. For example, the mobile device may display the user's player tracking information, such as the points the user has accumulated or other information.

It is noted that the user may be required to log in or otherwise verify his or her identity in one or more embodiments, prior to being permitted to view or use the promotions. Thus, the mobile device may request a PIN, username and password, or other identifying information prior to displaying the promotions. In some embodiments, the user may be required to identify him or herself once the mobile device's application software for promotions has been loaded or executed. It is noted that the user may have to verify his or her identity when redeeming promotions in some embodiments.

The mobile device may provide organized access to the promotions in other ways as well. For example, the mobile device may provide an option to view all promotions on the mobile device. In addition, the mobile device may allow the user to search for various promotions according to one or more criteria. Promotions may also be displayed according to their characteristics. For example, promotions may be displayed according to their expiration dates (e.g., from earliest expiration date to latest expiration date). As another example, promotions may be displayed according to their type (e.g., slot promotions, point promotions, credit promotions, and food and beverage promotions).

In one or more embodiments, the mobile device may detect its location and present promotions for nearby gaming establishments, for the establishment where the user is currently located, or both. This may occur automatically, or may be initiated by the user such as by activating a “Nearby Promotions” button, or the like.

At a step 716, the mobile device may retrieve one or more promotions for the selected gaming establishment previously pushed to or retrieved by the mobile device and stored on a storage device (or memory device) of the mobile device. In one or more embodiments, only promotions that are valid (e.g., not expired) may be retrieved. It is contemplated that expired promotions may be deleted or otherwise removed by the mobile device.

At a step 720, the retrieved promotions for the gaming establishment may be displayed or presented to the user. For example, a menu or list of promotions may be presented, such as shown in FIG. 8B. It is contemplated that related information may be presented as well. For example, in FIG. 8B, the mobile device presents the title of each promotion and the promotion's expiration date. Other information may be displayed as well. For example, a brief description of the promotion or an icon or other indicator identifying the type of promotion may be displayed associated with each or one or more of the promotions.

At a decision step 724, the user may choose to select at least one of the promotions. If a promotion is not selected, this may indicate that the user is not interested in the selected gaming establishment. Thus, the user may be permitted to return to step 708 to again select a gaming establishment.

If a promotion is selected, the promotion may be displayed to the user at a step 728, such as shown in FIG. 8C. As stated above, a promotion may comprise various images, text, audio, video, etc. . . . Thus, a variety of data related to the selected promotion may be displayed. For example, the title or name of the promotion, a description, terms or requirements of the promotion, redemption instructions, an expiration date, and the like may be displayed. This allows the user to better decide whether he or she wishes to redeem or take part in the promotions. It is noted that the user may select multiple promotions at step 724 in some embodiments. If multiple promotions are selected they may be displayed in a list or other combined layout at step 728.

Also, at step 728, the user may be provided with a “Redeem” or “Accept” button, or the like. The button may be configured such that its activation begins the process for the user to redeem or take part in the displayed promotion. For example, in FIG. 8C, a “Redeem” button is shown which, when pressed, begins the redemption process for the promotion shown. A “Decline” or “Cancel” button or the like may also be provided for the user to indicate he or she does not want to take part in the promotion. The “Decline” button may return the user to step 724 where another promotion may be selected. It is contemplated that other buttons may be provided as well. For example, a “More Information” button or the like may be provided to give the user access to further information about the promotion. As another example, in embodiments where the mobile device has phone capabilities, a “Call” button could be provided which, when pressed, causes the mobile device to call the gaming establishment. The user may then redeem the promotion or request further information over the phone.

At a step 732, the promotion may be redeemed. This may occur in a variety of ways. For some promotions, redemption may occur automatically through the mobile device. For example, promotions offering free credits or currency for a user to play one or more wagering games may be automatically credited to the user, such as through the user's player tracking or other account. In other words, for this example, activating the “Redeem” button would automatically credit the user's account.

This may occur in various ways. For example, the mobile device may communicate with the promotion server to initiate the redemption of a promotion. If necessary, the promotion server may then communicate with the player tracking system to update a player tracking account. In this example, the promotion server may credit amounts to the user's player tracking account. Once the promotion is redeemed, the mobile device may be notified or updated to reflect the redemption by communication from the promotion server, player tracking system, or both.

Promotions may require some action by the user. For example, as shown in FIG. 8D, the mobile device displays redemption information, such as a barcode or other identifier that may be read by a gaming machine at the gaming establishment to redeem the promotion. The user may be required to hold the barcode up to a gaming machine to redeem the promotion, such as to take advantage of better odds, free credits, point multipliers, or other promotions at the gaming machine. In general, as will be described below, the redemption information allows the gaming machine (or other equipment) to determine which promotion is being redeemed, the user redeeming the promotion, or both.

Of course, other machine readable identifiers aside from barcodes may be used as redemption information in one or more embodiments. For example, an RFID or other wireless transmission may be used in some embodiments. In addition, the mobile device may communicate redemption information via a wireless transmission such as through a Bluetooth or 802.11a/b/g/n communication device. In another embodiment, the redemption information may be alphanumeric or other characters that may be read by the user and inputted into a gaming machine or other equipment to redeem its associated promotion. It is noted that the redemption information may be pushed from the mobile device (e.g., transmitted by the mobile device) or pulled from the mobile device (e.g., retrieved from the mobile device) by a gaming machine or other equipment.

Combinations of identifiers may also be used. For example, in FIG. 8D, a barcode as well as alphanumeric characters are used. This is advantageous in that it allows redemption information to be inputted into gaming machines or equipment having various scanning or reading capabilities. In addition, it is contemplated that redemption information may be inputted in multiple steps or parts. For example, a portion of the redemption information may be provided by a barcode while another portion is provided by alphanumeric characters.

A variety of devices may be used to receive redemption information from a mobile device. For example, a bar code scanner, RFID reader, wireless communication device, keypad, or the like may be used. It is contemplated that in some embodiments, an image capture device and optical character recognition may be used. In these embodiments, redemption information comprising alphanumeric or other characters may be read. These devices may be in gaming machines (as described above) or in other equipment at an establishment to allow promotions to be redeemed. For example, a scanner or other reader, such as in the form of a kiosk, handheld, or other device, may be at the pit, sports book, restaurants, or other locations of the establishment. As another example, a point of sale device may have a barcode scanner that may be used to redeem promotions for free food or free beverages. A parking valet may have a similar reader or scanner to redeem promotions such as for free valet parking.

As stated, the redemption information may uniquely identify particular promotions to allow the promotions to be correctly redeemed. It is contemplated that such redemption information may be associated with promotions by the promotion server prior to sending promotions to mobile devices. For example, a promotion identifier may be stored with each promotion by the promotion server in a database or other data storage scheme. The identifier may be presented by a mobile device as part (or all) of the redemption information. In this manner, the gaming machine or other equipment at an establishment may query the promotion server with the identifier to determine the promotion to be redeemed and/or to confirm the validity or authenticity of the promotion.

The redemption information may, but need not, also include a user or player identifier. This identifier may be used to uniquely identify a user or player to allow the promotion system to be aware of who is redeeming a promotion. In one embodiment, the player identifier may be a player tracking number, such as shown in FIG. 8D. Of course, the player identifier may be a variety of identifiers capable of uniquely identifying a particular player or user. It is noted that the user or player identifier may be different based on the gaming establishment the user has chosen. For example, a player tracking number may be different depending on the gaming establishment or casino the user has selected.

To include player and/or promotion identifiers, the redemption information may have one portion for player identifiers and another portion for promotion identifiers. For example, the redemption information may comprise two barcodes (or the like) in one embodiment. Of course, both identifiers may be combined into one identifier in some embodiments. For example, the redemption information may comprise a single barcode (or the like) comprising both identifiers, or may be a single barcode that may be processed or decoded to reveal the individual promotion and player identifiers.

It is contemplated that a user may be required to verify his or her identity before a promotion may be redeemed. In one or more embodiments, the mobile device, gaming machine, or other equipment used to redeem a promotion may request verification from the user. For instance, the user's PIN, username and/or password, or other verification information may be requested. Once the correct information is entered the promotion may be redeemed for the user. It is noted that the verification information may be particular to a gaming establishment and that the user may be required to enter information specific to the gaming establishment (e.g., a PIN for a particular gaming establishment).

For example, in a preferred embodiment, when a user attempts to redeem a promotion, the user's identity is verified. Verification may occur by the user inputting or providing a player tracking or identification number. Alternatively or in addition, the user may provide a username and/or password, a PIN, or other identity verifying information. When such information is provided, it may be transmitted to the player tracking system 208, the promotion server 212, or both for confirmation. It is contemplated that a separate verification server or device may be used to confirm a user's identity.

If the player's identity is not confirmed, then the promotion may not be redeemed. In one embodiment, for example, a player transmits promotion information to a gaming machine. The gaming machine sends the promotion information to the promotion server 212. If the promotion is confirmed, the promotion server 212 may transmit the player's tracking number to the player tracking system 208 to confirm that the player that is seeking to redeem the promotion is the valid owner of the promotion.

If validated, then certain actions may be performed by the player tracking system 208. For example, if the promotion is the award of a certain number of player loyalty or rewards points, the promotion server may transmit such information to the player tracking server 208 to increase the player's rewards points. Likewise, if the promotion is a free game play or the like, while such games might be presented directly by the gaming machine 204, the gaming machine 204 preferably validates the promotion before presenting the games. This validation may occur via the promotion server 212 and/or player tracking system 208. After validation, the free game information may be transmitted to the gaming machine 204 to cause the machine to present the game.

Other ways of validating or authenticating promotions prior to allowing their redemption may be used. For example, a digital signature of a promotion may be sent to the promotion server to confirm the validity of a promotion before it may be redeemed. In one or more embodiments, a mobile device may validate a promotion with the promotion server 212 and/or player tracking system 208 prior to allowing the promotion to be displayed or presented for redemption. In these embodiments, it is contemplated that the gaming machine 204 need not, but may, independently validate the promotion as well.

It is noted that some promotions may not require a user to identify him or herself. For example, promotions not associated with a particular user or player may not require user identification. To illustrate, a promotion may provide benefits such as discounts, free goods, free services, or the like to any user. These promotions may be redeemed without identification (and without verification of the identification).

The promotion server may provide one or more instructions to the gaming machine or other equipment to implement (i.e., redeem) one or more promotions. This may be accomplished in a variety of ways. For example, in a promotion for 100 free credits, the promotion server may instruct or otherwise cause a gaming machine to provide 100 credits to the user when the promotion is redeemed. As stated above, in some embodiments, the promotion itself may include these instructions. In these embodiments, the gaming machine or other equipment may access the instructions of the promotions through the promotion server. Alternatively or in addition, the instructions may be provided by the mobile device (via push or pull) through a communication link or as part of the redemption information. If desired, the instructions may be verified with the promotion server such as by comparing the instructions provided by the mobile device with the instructions for the same promotion stored on the promotion server.

The instructions may be a variety of commands or parameters as stated above. For example, there may be instructions to activate bonus games, increase winning amounts, increase odds of winning, provide free spins, add credits, and the like. For non-gaming goods or services there may be instructions to provide discounts, free goods or services, two for one or other deals, free or reduced price lodging, and the like.

It is contemplated that the promotion system may work in a server-based gaming environment. In general, a server-based environment includes one or more game servers which provide game software or machine readable code to one or more gaming machines through a network or the like. In this manner, the gaming machines can implement a variety of games by executing various game software from the game servers.

The promotion system may utilize the functionality of the game servers to provide particular games to a user as part of a promotion. For example, as stated a promotion may offer the user one or more games with better odds, higher payouts, bonus games, free credits the like, or a combination thereof. Such games maybe retrieved from a game server and executed on a gaming machine when the promotion is redeemed. In one or more embodiments, these games may only be available to users through a promotion which further entices users to sign up for the promotion system. It is contemplated that games exclusive to users of the promotion system need not always be wagering games in all embodiments.

In addition, it is contemplated that the games may be highly customized in server-based (and other) embodiments. In fact, a game may be customized for an individual user based on the user's player tracking or other information. For example, a custom slot game may utilize the user's zodiac sign (from the user's birthdate) as a symbol on one or more reels. As another example, free credits in the amount of the user's age may be included in a game.

To allow such customization, it is contemplated that the game server may be configured to modify games to create custom games according to a promotion. For example, the game server may modify game parameters, graphics, instructions, and the like to create a custom game as offered by an associated promotion. In one or more embodiments, the game server may be preloaded with one or more games that are readily customizable or that have been previously customized for users of the promotion system. These games may then be provided to the users upon redemption of a promotion. The game server may communicate with a player tracking system, promotion server, or both to retrieve information about the user that may be used to generate games for the user or determine which game to provide a user when the user redeems a promotion.

The promotion server may track usage of promotions to allow promotions that are more successful to be distinguished from those that are less successful. Because the promotion server may be in communication with a player tracking system or other equipment at an establishment that is used to redeem promotions, valuable information regarding the success or lack thereof of promotions may be derived taking into account user demographics (such as age, income, residence, etc. . . . ) collected by the player tracking system. This may be used to increase usage of promotions as well as establishment patronage.

The promotion system provides various other features and benefits as well. For example, in one embodiment, the mobile device herein may be used to identify users for player tracking and other purposes. Thus, a user need not carry a separate player tracking card or other tracking device because the mobile device may be used to identify the player. This may be accomplished in various ways such as described above with regard to redemption information. For instance, the mobile device may provide a barcode or other identifier which identifies the user to a reader, scanning equipment, or the like at a gaming establishment.

It is contemplated that the mobile device may provide an automatic logout from a player tracking account when the user leaves the proximity or vicinity of a gaming machine or other wagering game. This prevents unauthorized use of the user's player tracking account, including unauthorized use or even redemption of the user's points. In traditional systems, it is relatively common to find that a user has left his or her player tracking card at a machine allowing for unauthorized used of the user's player tracking account. With the mobile device herein, the user may be automatically logged out of the account when the player leaves the area (or logs in to another gaming machine or other equipment). In this manner, even if the user forgets to log out, his or her account becomes inaccessible to unauthorized users when the user leaves the immediate area.

The proximity of the mobile device to a gaming machine or other wagering game may be determined in a variety of ways. For example, the mobile device's location device may be used to determine its position relative to a gaming machine. The signal strength or time delay of communications between a mobile device and a gaming machine may be used to determine proximity in some embodiments. Of course, other ways of determining proximity may be used as well.

The mobile device may also be configured to interact with a local network or other equipment at a gaming establishment, as stated above. This allows the mobile device to notify the gaming establishment of a user's arrival. For example, upon detecting the local network or detecting that the user is located within a gaming establishment, the mobile device may communicate the user's arrival to the gaming establishment. As a result, the user may be sent one or more promotions by the establishment's promotion system. These promotions may be designed to entice the user to play particular wagering games, have food or beverages, or purchase the establishment's goods or services that the user may not ordinarily partake in. In addition, where the local network provides a higher bandwidth connection, enhanced promotions incorporating video and the like may be provided when the user is in range of the local network.

In addition, establishment personnel may be alerted to the presence of a particular user as announced or provided by the user's mobile device. The personnel may personally greet the user and provide one or more promotions personally, or as stated, promotions may be provided on the user's mobile device. For example, a frequent patron of an establishment may be greeted by gaming or other personnel and provided a free meal or drink or other benefits upon arriving at the establishment. In gaming embodiments, personnel may also be notified of the type of player the user is or what types of games (e.g., slot games, pit games, sports betting) the user plays so that the personnel may focus their attention on these attributes of the user. For example, the personnel may notify the user of specials or promotions, events, or the like that relate to the types of games the user plays. This facilitates good relations with the patron ensuring that the patron enjoys his or her time at the establishment.

Likewise, the arrival of a user at various locations within an establishment may be announced or detected. For example, the mobile device may detect its proximity to gaming machines, the pit, the sports book, restaurants, clubs, or other locations of a gaming machine and transmit an alert or notification to the gaming establishment. Alternatively, a scanner or reader at these locations may detect the mobile device and obtain its user's identity. In this manner, establishment personnel may be made aware of the arrival of the particular user at these locations and provide customized greetings, services, promotions, and other benefits to the user.

Aspects of the promotion system used to provide particular promotions to users based on the users' location may be used to provide one or more multi-location promotions for a variety of gaming and non-gaming establishments in one or more embodiments. Multi-location promotions are highly beneficial in that they allow different offers to be presented to users based on the user's location. The ability to provide different offers to users allows establishments to fine tune their promotions. For example, users that are less likely to visit and/or make purchases at the establishment may be provided better offers or promotions than users that are more likely to visit and/or make purchases. To illustrate, in one embodiment, users that are farther away from an establishment may be given better promotions than users that are closer to the establishment. This is highly advantageous in that it allows an establishment to entice users that are farther away to come to the establishment and/or make purchases.

As will become apparent from the discussion herein, a particular aspect of the present invention relates to the distribution of promotions based upon the current location of a potential customer. Presently some stores obtain the home address of their customers and send them mailers. This system, however, does not account for the changing location of the customer over time. For example, a store might wish to sell a few remaining goods as quickly as possible on a certain afternoon. If the store sends out mailers, they may not be received by potential customers until days after the store wishes to run the promotion. By electronically transmitting the promotions, they can be received immediately. Moreover, by knowing the present location of customers, the promotion can be targeted to the potential customers. For example, a customer may be more likely to stop at a store and make a purchase based upon a promotion if the customer is close to the store. Thus, when a store wishes to sell certain remaining goods, the store may target the promotion to those customers who are in a zone closest to the store at that moment. Notably, various of these customers may have home addresses which are far from the store and would not have received such a promotion if it were based upon the customer's home address and not the present location of the customer. Likewise, knowing that certain customers who are far away from the store are unlikely to respond to a promotion that has a short duration (since the customer may not even be able to travel to the store before the promotion ends), the store may not even send promotion information to a potential customer who is determined to be in a remote zone at the time of the promotion (again, even though the customer may have a home address which is close to the store, that customer may actually be far from the store when the promotion starts).

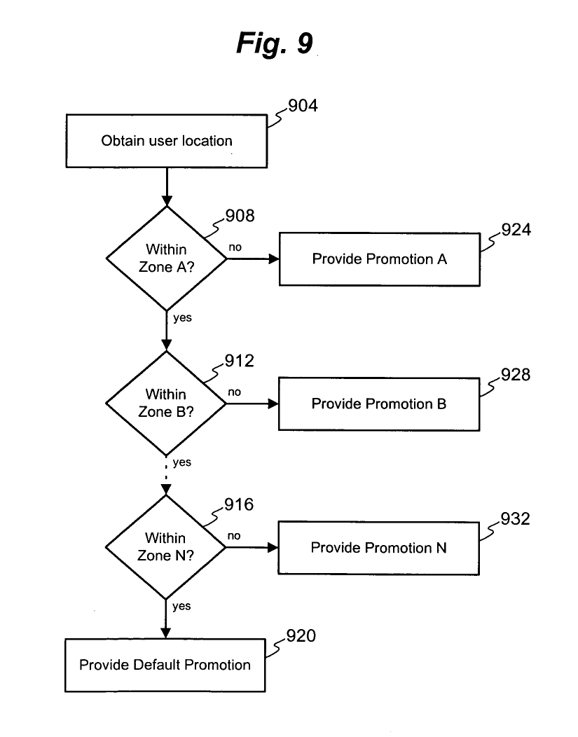

FIG. 9 is a flow diagram generally illustrating how multi-location promotions may be provided in one or more embodiments. Though shown in a particular sequence, it will become apparent from the following that various sequences of steps may be used.

At a step 904, a user's location may be determined. As stated above, the determination of a user's location may occur in various ways. Referring to FIG. 5, a mobile device 108 may comprise a location device 524 configured to determine the user's location. For example, the location device 524 may be a GPS receiver. As another example, the mobile device 108 may determine its location based on the location of another object. For example, a mobile device 108 may determine its location based on its vicinity to wireless transceivers, such as WiFi hotspots or cellular transceivers having known locations. U.S. Pat. No. 6,353,797 describes a variety of ways of determine a user's location which are herein incorporated by reference.

Referring back to FIG. 9, once the user's location is known, a particular promotion may be provided to the user based on his or her location. For example, at a decision step 908, it may be determined if the user is within a first zone or area relative to the establishment. If so, a first promotion, such as Promotion A as shown in FIG. 9, may be provided to the user at a step 924. If the user is not within the first zone, it may be determined at a decision step 912 if the user is within a second zone. If the user is within the second zone, a second promotion, such as Promotion B as shown in FIG. 9, may be provided to the user at a step 928.

It is contemplated that distinct promotions for two or more zones may be provided by the multi-location promotion system. For example, as shown in FIG. 9, there may be up to n zones, where n is an arbitrary number. In one or more embodiments, each of the zones may have a decision step, such as decision step 916, where it is determined whether or not a user is within a zone. Each zone may also have its own unique promotion, such as shown by Promotion N of FIG. 9, which may be provided to a user at a step 932.

The promotion server may be configured to make the determination of whether or not a user is within a zone. Once determined, promotions may be provided by the promotion server selecting the associated promotion and sending it to the user's mobile device. The promotion server may be made aware of the user's location may the user's mobile device. This may occur in various ways. In one embodiment, the mobile device may continuously or at periodic intervals transmit the mobile device's location to the promotion server.

In another embodiment, the promotion server may send a triggering message requesting the mobile device's location. In response, the mobile device may send its location to the promotion server. This is beneficial in that the mobile device need not continuously send its location, which may consume excess amounts of power. The triggering message may be a “push” type notification. For example, a specially coded SMS message may be sent to the mobile device as a triggering message. The mobile device may be configured, such as by application software, to detect the triggering message and respond accordingly by transmitting its location.

In some embodiments, the mobile device may be configured, such as by application software, to determine if a user is within a zone and, if so, to present the associated promotion to the user. In such embodiments, it is contemplated that all promotions for an establishment may be sent to and stored on the mobile device. For instance, the promotion server may send all promotions for an establishment to the mobile device. The mobile device may then compare its location to the zones identified in the promotions. If its location is within a zone, the mobile device may provide the associated promotion to the user. Promotions associated with other zones will remain inaccessible to the user and thus are not provided to the user (though they are stored on the mobile device).

It is noted that the application software (such as machine readable code) may be provided with a mobile device, downloaded to the mobile device, or otherwise installed on the mobile device. In addition, the mobile device may be hardwired and/or programmed to provide the functionality described herein. In one or more embodiments, the application software, hardwiring, or programming may be configured to interact with a promotion server to allow a user to utilize the multi-location promotion system.

In one or more embodiments, if the user is not within any zone, a default action may occur. For example, if the user is not within any zone, a default promotion may be provided to the user, such as illustrate by a step 920. It is contemplated that the default promotion may be distinct from the promotions associated with the zones, or that the default promotion may be one of the promotions associated with the zones. It is also contemplated that that a plurality of unique promotions may be associated with each of the zones.

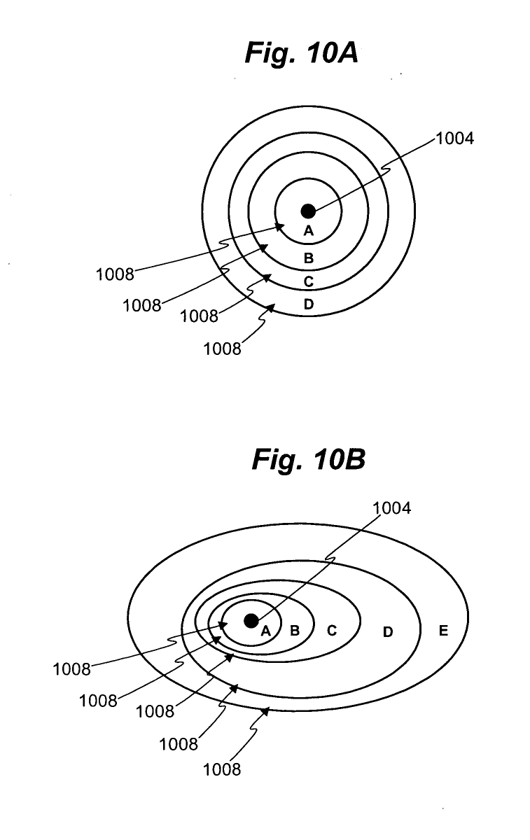

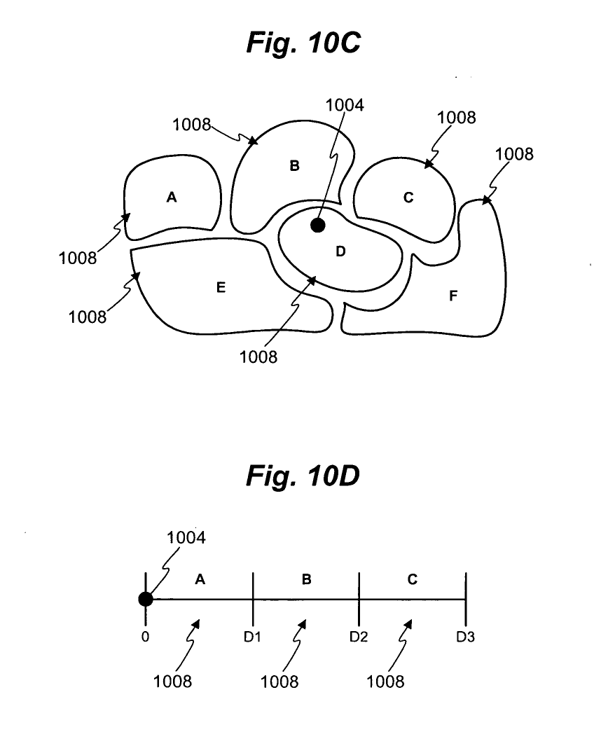

In general, a zone is a geographic area within which one or more users may be located. Zones may be defined in a variety of ways. For example, in FIG. 10A, zones 1008 have been defined by concentric circles at increasing distances around an establishment 1004. In other words, as shown, each geographic area between the circles is a zone 1008. FIG. 10A illustrates four zones 1008, namely Zone A, Zone B, Zone C, and Zone D. In this embodiment, the zones 1008 correspond to increasing distances from the establishment 1004. This is beneficial in that increasingly better promotions may be provided as the distance from the establishment 1004 increases. For example, Zone D may have a better promotion than Zones A-C. Of course, the “quality” of the promotions for particular zones 1008 may vary as defined by an establishment 1004.

FIG. 10B shows another possible configuration of the zones 1008 and that the zones may have a variety of shapes and locations. For instance, as shown, the zones 1008 of FIG. 10B correspond to increasing distances from the establishment 1004 but are not centered around the establishment 1008.

The zones 1008 need not be concentric and, in fact, may define any number of geographic areas. For example, FIG. 10C illustrates zones 1008 which are independent in that they are not surrounded by other zones. This is beneficial in that it allows zones to be better defined according to user demographics. For example, a sporting goods establishment 1004 may wish to provide particular promotions for users who live near mountains and other promotions for users who live near bodies of water. It is contemplated that concentric zones may be defined according to user demographics as well.

Geographic areas of the zones 1008 may be defined logically in one or more embodiments as will now be described. FIG. 10D illustrates a distance chart that provides a visual representation of three zones 1008, namely Zone A, Zone B, and Zone C. In general, these zones 1008 correspond to a distance from an establishment 1004. To illustrate, Zone A is a distance between 0 and D1 miles from the establishment 1004, where D1 is a first distance. Zone B is a distance between D1 miles and D2 miles from the establishment 1004, where D2 is a second distance. Likewise, Zone C is a distance between D2 and D3 miles from the establishment 1004, where D3 is a third distance.

Though it may appear that this defines zones 1008 similar to that of FIG. 10A, these zones are distinct in that they be used to define zones based on the distance that must be traveled along one or more travel paths or routes (e.g., road, highway, track, waterway, etc. . . . ) from the user's location to the establishment 1004. For example, a user may geographically be a distance X from an establishment 1004 on a direct line to the establishment. In actually however, the user may be a distance Y from the establishment 1004 because there is no travel route that follows the direct line between the user's location and the establishment.

Since there may be numerous geographic areas which are a particular distance, via existing travel routes, from the establishment 1004, defining zones 1008 in this manner allows establishments to easily associate one, some, or all of these geographic areas to a zone by the travel distance to the establishment.

As is known, a variety of routes may be taken to get to an establishment in many cases. For this reason, the multi-location promotion system may determine a distance between the user and an establishment based on at least one of these routes. For example, the shortest route between the user and the establishment may be used to determine which particular promotion will be provided to the user.

In some embodiments, multiple routes may be taken into account to determine the user's distance from the establishment. In fact, all the routes may be taken into account in some embodiments. For example, a distance between the user and establishment may be determined for a plurality of routes between the user and the establishment. These distances may then be averaged or otherwise aggregated to determine a distance of the user. This is beneficial in that it is difficult to predict which route a user will take to the establishment. By averaging or aggregating a plurality of distances, a more accurate “distance” between the user and establishment may be determined for the purpose of providing a particular promotion.

To illustrate, in an exemplary situation where there are 3 routes between a user and an establishment. The distance of each of the routes may be averaged, such as by adding them together and dividing by the total number of routes. [PROVIDE MORE EXAMPLES OF DISTANCE DETERMINATION IF DESIRED]

It will be understood that though illustrated in FIGS. 10A-10D as having a particular number of zones, fewer or additional zones 1008 may be provided by the multi-location promotion system. In addition, zones 1008 for a single establishment 1004 may be defined in one, some, or all the ways indicated herein.

An establishment may define one or more promotions for each zone. Typically, the promotions will be unique at least between zones. The establishment may then send the promotion to a promotion server, such as described above with regard to FIG. 4, for distribution to users. The establishment may identify a zone to which its promotions are to be associated. In this manner, users may be presented only the promotion(s) for the zone where they are located. The promotion server may store a promotion along with an identifier which indicates which zone the promotion is associated with, such as in a database or other storage format.

It is contemplated that the establishment may also provide promotions to a promotion server in the form of an inventory or listing of goods or services offered by the establishment. The goods or services may be associated with different promotions depending on which zone a user is in. For example, the establishment may define particular prices, discounts, or the like for users within one zone and define different prices, discounts, or the like for users within another zone. To illustrate, a user that is further away from the establishment may be provided a 20% discount for a good or service while a user that is closer to the establishment may be provided a 10% discount. This is in keeping with the multi-location promotion system's methodology for providing better promotions to users that are less likely to visit or make purchases at an establishment.

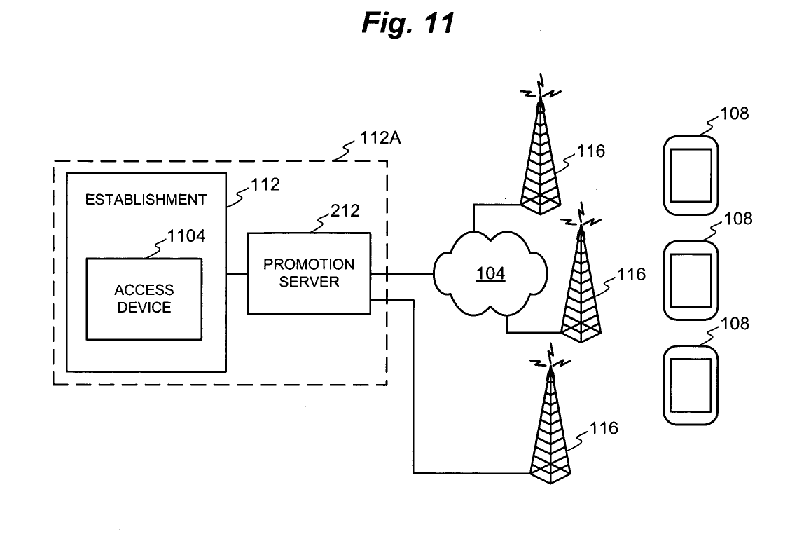

FIG. 11 illustrates an exemplary relationship between an establishment 112 and a promotion server 212. It is noted that the establishment 112 may be a gaming or non-gaming establishment. Though not illustrated, a single promotion server 212 may be in communication with multiple establishments 112 to provide multi-location promotion services to the establishments (e.g., store and distribute promotions for multiple establishments). This is beneficial in that a user may be provided promotions from various establishments from a promotion server 212. In addition, a user may request promotions for various establishments from a promotion server 212.

As can be seen, an establishment 112 may utilize an access device 1104, such as a computer, server, or the like, to communicate with the promotion server 212. For example, the access device 1104 may be used to create, modify, and/or delete promotions, zones, and other information on the promotion server 212. As set forth above, the promotion server 212 may be in communication, directly or through one or more networks 104, with one or more transceivers 116 to allow communication with one or more user devices 108.

It is noted that in some embodiments the promotion server 212 may be a third party server or a central server that may be shared among multiple establishments. For instance, as shown in FIG. 11, the promotion server 212 is remote from the establishment 112. Alternatively, the promotion server 212 may be a server of an establishment 112A. This alternative embodiment is optional as shown by the dashed line illustrating the exemplary establishment 112A that contains the promotion server 212.

It is contemplated that the promotion server 212 may be in real-time communication with the access device 1104 in some embodiments. This is beneficial in that the establishment's access devices 1104 may provide real-time inventory updates to the promotion system. In this manner, promotions to users can be made for particular goods or services which are actually available to the users. In this way, promotions may be provided based on the availability of goods or services at an establishment 112.

As discussed above, promotions may be provided to users at various times, as desired by an establishment. In addition, the establishment may schedule one or more times to send promotions to users. It is contemplated that users may request promotions in one or more embodiments. For example, a user may request promotions for particular goods or services from particular establishments. In response, one or more promotions for the user's zone may be sent to the user, such as from a promotion server.

The functionality provided by the multi-location promotion system provides additional benefits to users and establishments seeking/providing goods or services. For example, because a promotion server may store a variety of promotions for one or more establishments, it is contemplated that a user may request promotions for particular goods or services. In response to such request, the promotion server may send promotions matching the requested goods or services for the user's zone.

In addition, the multi-location promotion system allows establishments to target users in particular zone(s) for limited-time or impulse promotions. This may be accomplished by including an expiration time for the promotion. For example, in a period of slow sales, the establishment may create and distribute a promotion to increase visits or purchases during this time. To illustrate, the establishment may distribute a promotion for a period of time in the afternoon (or other time) where sales are typically slow. The promotion may be configured to expire after a limited time such as after one or more hours or smaller periods of time.

The limited time nature of the promotion serves to encourage users to visit and make purchases at time periods specified by the establishment, such as periods of time where sales are slow. In some cases offer(s) made by a limited-time promotion may have increased benefits as compared to other promotions to further entice users to visit and make purchases. The multi-location system allows establishments to distribute various limited-time promotions to “find” the right mix of expiration time and offered benefits to achieve the desired level of user visitation and purchases.

As an example, an electronics retail establishment may wish to increase visitation and sales for a two hour period in the afternoon. In this case, the establishment may create and distribute one or more promotions that expire in two hours. The establishment may also select which zone or zones in which to distribute the promotions. For example, the establishment may distribute the promotions in a nearby or surrounding zone, such as to entice users who are or who happen to be near the establishment.

Because the promotion may be time as well as zone limited, the establishment is free to distribute promotions that include extremely beneficial offers to users without worrying about having too many reduced cost purchases. The establishment may utilize these capabilities to trigger impulse or other purchases. For example, the enticement of a reduced price or other benefit combined with the limited-time nature of this benefit may be enough to cause users, who would otherwise not be interested in making purchases, to make purchases. This allows purchases to be increased for particular periods of time, in a manner desired by the establishment.

As another example, an establishment may wish to quickly reduce or eliminate remaining inventory for one or more goods. For example, an establishment may wish to “blow out” its remaining inventory on a particular model television. One or more limited-time promotions may be used to promote purchases of the television. To illustrate, the establishment may distribute a promotion to users within a nearby or surrounding zone with substantially reduced pricing on the television for a limited period of time. Users (even those who may not have been seeking a television) may be enticed by the limited-time reduced pricing to purchase the television, thus reducing the establishment's inventory in the time period desired by the establishment. Because the promotion system may tie into the establishment's inventory system, the promotions may also present and update the quantity of remaining inventory. As the inventory diminishes, the user may be further enticed to make a purchase at the establishment.

In some embodiments, users may be permitted transmit or provide information to a promotion server, such as through their mobile device. For example, a user may be permitted to define a search zone around their current location in which to search for promotions. In this manner, the user may request promotions for particular goods or services within a radius, travel distance, or other user-defined area near or at the user's current location.

To illustrate, a user shopping for a television may request promotions for televisions within a 2-mile radius of his or her current location. In response, the promotion server (or the server(s) of multiple locations/establishments) may send a list of television promotions for establishments that are within this radius. In one embodiment, the promotions provided to the user may be those associated with a zone that at least partially overlaps the user-defined zone or radius. It is noted that the user's mobile device may accept a variety of search criteria for goods or services. For example, the user may be permitted to specify prices, brands, particular features, and the like when requesting promotions.

Because a promotion server may have access to an establishment's inventory of goods or services, the promotion server may also or alternatively provide a list of establishments within the user-defined zone that provide the goods or services the user is seeking. A list of goods or services matching those the user is seeking may also or alternatively be provided. In one or more embodiments, the promotion server may provide pricing information with such a list.

The promotion server may be configured to automatically generate promotions in response to a user request. In one or more embodiments, one or more promotions having a predefined benefit for the purchase of one or more goods or services matching the user's request may be generated. For example, one or more promotions having a predefined discount for the matching goods or services may be generated and distributed to the user in response to the user's request.

The automatically generated promotions may take into account the zone in which the user is located and provide a different predefined benefit based on the user's zone. For example, a first set of predefined benefits may be provided to users in a first zone, while another set of predefined benefits may be provided to users in another zone. It is noted that if the establishment has previously created a promotion that applies to the goods or services the user is requesting, the previously created promotion may be provided to the user instead of an automatically generated promotion in one or more embodiments.

Other information or feedback may be provided from the user to the promotion system in some embodiments. For example, a user may reserve or place goods or services on hold for a period of time. A “Hold” button or the like may be presented on the user's mobile device to hold a good or service for a period of time. It is contemplated that, in some embodiments, the user may be required to make at least a partial payment via his or her mobile device in order to hold a good or service. In addition or alternatively, the user may actually purchase a good or service offered by a promotion through his or her mobile device. For example a “Buy” button or the like may initiate a purchase transaction, such as a credit card or other electronic transaction, between the user and the establishment.

The options presented to a user may be dependant on the zone in which the user is located. For example, only users in a first zone may have the ability to place goods or services on hold, have the ability to make purchases via their mobile devices, or both. This is advantageous in that it allows establishments to control where these options are presented. For instance, an establishment may only desire that users in a nearby or surrounding zone be given the option to hold goods or services because they may be more likely to visit the establishment to complete the purchase. Users in other zones may be given only the option to buy goods or services.

It is contemplated that the user may request the quantity of remaining inventory in some embodiments. For example, an “Availability” button or the like may be provided to query and establishment's inventory for availability of a good or service. The user may confirm availability before traveling to the establishment in this manner. In addition, where inventory is low, this may entice the user to make a purchase.

The ability to provide inventory information on demand is highly advantageous, especially in limited-time promotions. The quantity of remaining inventory may serve as further enticement to make purchases, as well as to inform users that a good or service is still available. This is beneficial in cases where users assume the good or service is sold out or otherwise unavailable.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A multi-location promotion system comprising:
at least one computing device configured to receive one or more promotions from one or more establishments, each of the one or more promotions associated with one of a plurality of zones, wherein the one or more promotions associated with at least two of the zones differ from one another; and
a wireless transceiver configured to receive a location of a mobile device and to communicate the location of the mobile device to the computing device;
wherein the at least one computing device is configured to determine if the location of the mobile device is within one of the plurality of zones and to send an associated promotion to the mobile device, the associated promotion being one of the one or more promotions associated with the one of the plurality of zones containing the location of the mobile device.

2. The promotion system of claim 1, wherein the one or more promotions comprise:
one or more first discounts and one or more second discounts to one or more goods offered by the one or more establishments;
wherein one or more of the one or more promotions having the one or more first discounts are associated with one or more of the plurality of zones that are one or more first distances away from the one or more establishments, and wherein one or more of the one or more promotions having the one or more second discounts are associated with one or more of the plurality of zones that are one or more second distances away from the one or more establishments, the one or more first discounts smaller than the one or more second discounts, the one or more first distances smaller than the one or more second discounts.

3. The promotion system of claim 1, wherein the one or more promotions comprise: one or more first discounts and one or more second discounts to one or more services offered by the one or more establishments;
wherein one or more of the one or more promotions having the one or more first discounts are associated with one or more of the plurality of zones that are one or more first distances away from the one or more establishments, and wherein one or more of the one or more promotions having the one or more second discounts are associated with one or more of the plurality of zones that are one or more second distances away from the one or more establishments, the one or more first discounts smaller than the one or more second discounts, the one or more first distances smaller than the one or more second discounts.

4. The promotion system of claim 1, wherein the at least one computing device comprises an interface configured to accept the one or more promotions and to associate each of the one or more promotions to one of the plurality of zones.

5. The promotion system of claim 1, wherein the wireless transceiver is a cellular transceiver.

6. The promotion system of claim 1 further comprising one or more instructions stored on a storage medium of the mobile device, the one or more instructions configured to send the location of the mobile device to the wireless transceiver.

7. The promotion system of claim 6, wherein the one or more instructions are configured to identify a triggering message from the wireless transceiver and, in response, send the location of the mobile device to the wireless transceiver.

8. The promotion system of claim 1 further comprising an access device configured to send one or more promotions created by the one or more establishments to the at least one computing device.

9. A multi-location promotion system comprising:
at least one computing device comprising at least one processor in communication with at least one storage medium;
zone information defining at least a first and a second zone, the zone information stored on the at least one storage medium; and
one or more promotions stored on the at least one storage medium, wherein at least one first promotion of the one or more promotions is associated with the first zone and at least one second promotion of the one or more promotions is associated with the second zone;
wherein the at least one processor configured to generate one or more signals configured to wirelessly transmit the at least one first promotion to one or more of the one or more users located in the first zone and to wirelessly transmit the at least one second promotion to one or more of the one or more users located in the second zone.

10. The promotion system of claim 9 further comprising a mobile device configured to send a location of the mobile device to the at least one processor, wherein the at least one processor utilizes the location of the mobile device to determine a location of the one or more users.

11. The promotion system of claim 9 further comprising a mobile device configured to receive a triggering message from the at least one processor and, as a result, to send a location of the mobile device to the at least one processor wherein the at least one processor utilizes the location of the mobile device to determine the location of the one or more users.

12. The promotion system of claim 9, wherein the at least one computing device is configured to provide an interface to accept the one or more promotions from one or more establishments.

13. The promotion system of claim 9, wherein the at least one first promotion provides a first discount and the at least one second promotion provides a second discount, the first zone closer to an establishment than the second zone and the first discount less than the second discount.

14. A multi-location promotion system comprising:
at least one computing device in communication with at least one storage medium;
zone information stored on the at least one storage medium, the zone information comprising a plurality of zones for one or more establishments;
one or more promotions stored on the at least one storage medium, each of the one or more promotions associated with one of the plurality of zones, wherein the one or more promotions are unique from one another; and
at least one mobile device configured to determine a location of a user of the at least one mobile device and to receive the one or more promotions from the at least one computing device, wherein the at least one mobile device is configured to present only one or more of the one or more promotions associated with a zone of the plurality of zones which contains the location of the user.

15. A method for providing promotions with a multi-location promotion system comprising:
receiving a plurality of zones comprising a first zone and a second zone from an establishment;
receiving a plurality of promotions comprising a first promotion and a second promotion from the establishment;
associating the first promotion with the first zone and the second promotion with the second zone, the first promotion and the second promotion differing from one another;
storing the plurality of promotions on at least one storage device in communication with at least one computing device;
determining a location of at least one wireless communication device user by receiving location information from the at least one wireless communication device;
determining if the user is located in the first zone or the second zone; and
if so, transmitting the first promotion to the user's wireless communication device through at least one wireless communication link to the user's wireless communication device.

16. The method of claim 15 further comprising sending a triggering message to the at least one wireless communication device to cause the at least one wireless communication device to determine the location of the at least one wireless communication device and to send the location to the wireless transceiver.

17. The method of claim 15, wherein the first zone and the second zone comprise at least two geographic areas.

18. The method of claim 17, wherein the at least two geographic areas differ by distance from the establishment offering the first promotion and the second promotion.

19. The method of claim 15 further comprising receiving a request for the plurality of promotions from the at least one wireless communication device, wherein the first promotion is sent to the one or more of the one or more mobile devices in the first zone.

20. The method of claim 15 further comprising receiving at least one of the plurality of promotions and at least one of the plurality of zones from one or more additional establishments.

21. The method of claim 15, wherein receiving the location of the at least one wireless communication device occurs through at least one cellular transceiver.
